(19) United States
(12) Patent Application Publication
(10) Pub. No.: US 2024/0095313 A1
(43) Pub. Date: Mar. 21, 2024

(54) User-Controllable AV-Artwork Steaming Data Structure with Conjunctive Configurable NFTs and Landscape-Portrait Coding

(71) Applicant: BLACKDOVE, INC., Miami, FL (US)

(72) Inventors: Marc Stuart Billings, Miami, FL (US); Albert J. Angel, Miami Beach, FL (US)

(21) Appl. No.: 18/123,795

(22) Filed: Mar. 20, 2023

Related U.S. Application Data
(60) Provisional application No. 63/321,269, filed on Mar. 18, 2022.

(51) Int. Cl. G06F 21/10

(52) U.S. Cl. CPC G06F 21/1015; G06F 21/1085

(57) ABSTRACT

Streaming artwork data structure/method with selection and temporal controls operates accessing artwork/audio datastores (visual, AV art, and audio). View-display and acoustic-player presents art and audio. Data structure uses display-side controller (DSC) operative on view/acoustic-player and uses streaming controller (SC) accessing art/audio datastores. User selects art/audio (a play-one), he/she applies temporal play (TP) command (cmd) on play-one via DSC. If an AV art, then SC applies audio override. A user personal profile (UPP) stores play-ones, TP, audio selection, selected audio play one, display link, and for AV art, the audio override. Upon user-actuated play-cmd from DSC, SC obtains art/audio/override, then downloads to DSC for view/acoustic-play. Enhancements include art with portrait/landscape format labels activating DSC to change art displayed on viewer to portrait/landscape. DSC accepts artwork playlist and TP has: single, uniform, per-playlist, repeat and random playtimes. Artwork may be on NFT datastore with access provided via NFT art token.

This is a non-provisional patent application based upon and claiming the priority of provisional patent application Ser. No. 63/321,269, filed Mar. 18, 2022, the contents of which is incorporated herein by reference thereto.

The present invention relates to a data structure for user controllable artwork and/or AV artwork which artwork is streamed to a user viewing display and, for AV artworks, the view display is coupled to an audio acoustic player. The data structure, system, and method operates in conjunction with artwork datastores (storing visual works and AV works), and in some situations, audio datastores which enable display of the artwork simultaneous with audio from a user selected audio track or programmic system selection. The artwork may be stored or accessed through a non-fungible token (NFT) blockchain. A DAO management data structure, using blockchain and embedded smart contracts to operate the DAO which oversees operation of the NFT stored and distributed artwork. The artwork may be encoded with landscape or portrait format coding thereby permitted the viewing display of the artwork in the proper format, that is, either landscape or portrait.

### BACKGROUND OF THE INVENTION

Art has evolved over the millennia. In the most recent century art has birthed a new, and vibrant format: video art. Like static art, video art embodies unique artistic expression. The number of works of art in static, video or audiovisual format (hereinafter “Art” refers collectively refers static art, video art and audiovisual art) has proliferated bolstered by the ever-expanding evolution of art creation software tools and audiovisual programming capabilities. Software that enables audio visual creation and editing has spawned myriad artistic creations allowing for an infinite number of unique and original works. Simultaneously, following the invention of the television a variety of business models emerged (e.g. broadcast, cable, and streaming); each business model controls distribution and integrates a monetization model.

The emergence of interconnected global internet networks facilitated distribution of video clips, TV programs, static art and video art globally. It was not until relatively very recently that the awareness that Art could be discovered and appreciated in an online context began to emerge. Art appreciation evolved through stages of broadcasting, narrowcasting, streaming, sharing, sale and resale. The instant invention relates to the structure, system and method inherent in a pioneering platform that allows for the discovery of new artists and their artistic works. It also describes how that platform permits distribution, digital rights management, user preference control and business functions that include compensation to the Art creator and owner(s). The invention integrates unique capabilities to distribute, display and monetize this Art. The invention also embraces a fusion of structures, systems, and methods that leverage platform capabilities powered by digital rights management, blockchain and NFT commerce, royalty administration and programmatic search and display options including user preference, platform preference and artificial intelligence influenced formats.

Prior art systems are currently used to display short form videos or video clips while the actors perform to musical content (AV artwork content). Artists creating these short form videos or video clips seek to commercialize their work. Also, visual art artists seek to expand and commercialize their static, visual art (generically referred to as artwork, for example, paintings and two-dimensional artworks) to at-home and in-business displays, for example, televisions and other types of display monitors.

A problem exists in displaying a single, visual art image (for example, a painting) for a long period of time on a display monitor. Such long-term display is not pleasurable to the viewer because the viewer becomes bored looking at the same static, two-dimensional art. Therefore, there is a need to sequentially present and display these static, two-dimensional visual art images on a television and other display monitor. Another problem is that these static, two-dimensional visual art images are sometimes best presented in a portrait format and at other times best presented in a landscape format. Hence, the display system needs to adjust for any particular static visual artwork. The same control-display issue may apply to video clips. Visual art is created in various sizes and sometimes is best presented in a portrait format as compared to a landscape format. In conjunction with art streaming to a viewing display, prior art systems cannot adjust or account for a portrait formatted visual art as compared to a landscape formatted visual art. Therefore, there is a need to adjust and match the display of artwork on a viewing display monitor or television.

A further problem exists with respect to the short form videos or video clips in that a single presentation or display of the video clip is often times not sufficiently long to permit the user to enjoy all aspects of the video clip. Therefore, there is a need for repeating that video clip, in a sequential, repetitive manner, such that the user or viewer can appreciate all aspects of the video clip over a longer period of time.

Additionally, there is a need to establish a convenience play list for the artwork consisting of multiple art pieces. User controls for art work play lists with temporal play commands are not currently available. Further, a data structure permitting display and control of artwork maintained or accessed on an NFT blockchain is not currently available.

### OBJECTS AND SUMMARY OF THE INVENTION

It is an object of the present invention to provide a data structure with a user controllable art, including visual artwork and AV artwork steaming data structure and method with conjunctive and configurable NFTs and with landscape or portrait format coding.

It is another object of the present invention to provide and operate a data structure for user controllable art including static art and video artwork and/or AV artwork which artwork is streamed to a user viewing display and, for AV artworks, the view display is coupled to an audio acoustic player. The data structure, system, and method operates in conjunction with artwork datastores (storing visual works and AV works), and in some situations, and audio datastores which enable display of the artwork simultaneous with audio from a user selected audio track. The data structure takes full advantage of the Internet of Things, JOT, the enable access to artwork databases, access to NFT-based artwork, collect this artwork and efficiently display the artwork, all with temporal control and user-based art-selected playlists. Collectability of artwork is an important aspect of the present invention. Also, the user's ability to curate the art, as an art collection, has supplemental value to the individual pieces of art. In other works the curated art collection may have more value that a summation of values of each of the art pieces.

It is object of the present invention to provide a data structure wherein the artwork may be stored or accessed through a non-fungible token (NFT) blockchain. A DAO management data structure, using blockchain and embedded smart contracts to operate the DAO which oversees operation of the NFT stored and distributed artwork is one embodiment.

Further objects of the present invention involve providing a method for streaming artwork with selection and temporal user controls which includes providing an artwork datastore which stores digital versions of artwork. The term artwork includes a plurality of discrete visual art pieces and a plurality of discrete audio/visual (AV) art pieces. This artwork datastore being one or more artwork databases, a cloud-based artwork datastore, an on-chain non-fungible token (NFT) datastore, or an off-chain NFT datastore.

It is another object of the present invention to provide a system and a method for distributively streaming artwork with selection and temporal user controls. The artwork datastore has digital versions of artwork (a plurality of discrete visual art pieces and a plurality of discrete audio/visual (AV) art pieces). The artwork datastore may include one or more artwork databases, artwork cloud datastores, an on-chain non-fungible token (NFT) datastore, or an off-chain NFT datastore. A user is provided a user view display for viewing the artwork. A display-side (DS) controller controls the artwork on the view display. The artwork is sent from a distributive streaming controller communicatively coupled to the display-side controller. The DS controller accepts a user artwork selection for a selected play one visual art piece or AV art piece. The DS controller also accepts a temporal play command in connection with the selected play one art piece. The selected play one and the temporal play command is stored in a user personal profile (UPP). Typically, but not always, the UPP is initialized with this data. The display-side DS controller enables presentation of the artwork selection based upon an art play command on the view display in compliance with the temporal play command. In a single art piece display, the temporal command is a per-art-piece timeframe which limits the artwork display to that pre-programmed timeframe. The distributive streaming controller, upon the art play, either substantially contemporaneous with the art play, downloads the artwork selection and temporal play command to the display-side controller or, prior to the art play command, has downloaded the artwork selection and temporal play command to the display-side controller. Reference to a streaming controller is not meant to encompass a distinct type of download action but encompasses continuous streaming, intermittent segmented streaming and pre-play-now command download of the artwork (either a single artwork or a playlist of artworks) to the display-side controller. This pre-play-now download is dependent upon the DS controller memory (for example, this controller may have a DVR memory).

A further object of the present invention includes visual art pieces and AV art pieces artwork best viewed in a portrait or a landscape format. These artworks have either a portrait-format code or a landscape-format code associated with the digital versions. When the selected play one art piece includes a portrait/landscape format code, the streaming controller downloads to the display-side controller the corresponding portrait/landscape format code. In in the presence of the specific format code, the display-side controller adjusts the view display for ether portrait or landscape view display. An enhancement includes the use of a mechanical rotational positioner coupled to and controlled by the display-side (DS) controller. The positioner is attached to the view display and rotates the view display to either a portrait or a landscape portrayal.

Additional objects of the invention include using an acoustic player for AV art pieces. Also the DS controller accepting an artwork playlist representing a number of artwork selections or pieces to be displayed in a sequential display order on the view display. The artwork playlist encompasses the selected play one command. The artwork playlist in the UPP. The temporal play command includes a single distinctive per-artwork playtime, a uniform per-artwork playtime for the sequential presentation of the artworks, a per-playlist playtime for the sequential presentation of the artworks, a repeat playtime, and a random playtime.

To enhance efficiency of the data structure, each artwork selection has a corresponding datastore address and, in a similar manner, the artwork playlist is a list of datastore addresses. These addresses are stored in the UPP for quick access to the selected artwork by the streaming controller. NFT artwork datastore are described later.

It is also an object of the present invention to provide a data structure permitting access to an audio datastore which has a plurality of discrete audio pieces. A user's view display and a user's acoustic player permits user viewing and display of the artwork. The acoustic player permits audio presentation of the audio pieces simultaneously with the AV art pieces.

Another object of the present invention includes a data structure with a display-side (DS) controller operative to control the user's display and the acoustic player. As described in the detailed description of the invention, the display-side controller may be a set top box (STB), or a ROKU® type device, or an APP on a cell phone, tablet or smart TV. Effectively, the DS controller is a media player. Also, the invention includes a distributive streaming controller communicatively coupled to the display-side controller. This second controller accesses artwork from the datastores and, in some instances, audio form the audio datastores. Reference herein to a streaming controller is not meant to encompass the type of artwork download to the display-side controller. In other words, the streaming controller could (a) download all artwork to the display-side controller (DS controller) such that the DS controller retains in its memory all the selected artwork (similar to a set top box STB with a DVR or other memory unit); or (b) stream the artwork in real time to the DS controller; or (c) engage in interment downloads of artwork given the bandwidth of the communication channel and the memory in the DS controller.

Further objects of the present invention involve a data structure which accepts a user artwork selection for a selected play one visual art (VA) piece or AV art piece. Also, the objective is to accept a user temporal play command in connection with the selected play one VA piece. In a refined embodiment, the temporal command is a per-piece playtime, a repeat, a skip, and a per-art-sequence playtime. The data structure accepts a user audio selection for one audio piece wherein the selected audio play one audio piece includes a display link associating the audio piece with the selected artwork piece. In this manner, the audio is played with the artwork display. Another objective, if an AV art piece is to be displayed, based upon the display link data, the streaming controller downloads to the display-side controller an audio override command.

It is also an object of the present invention to provide a data structure including the use of a user personal profile (UPP) which stores (in a UPP database or datastore) the artwork selection (a representation of the artwork piece or pieces selected by the user), the play one piece command, the temporal play command, the audio selection (a representation of the audio piece) if the user made such audio selection, the selected audio play one command, the display link, and for the AV art piece display link, the audio override.

Another object of the present invention includes a data structure wherein the streaming controller, upon a user-actuated art play command obtained from the display-side controller, obtains the artwork selection from the artwork datastore using the artwork selection code and obtaining the audio selection from the audio datastore. This server then downloads the artwork and the audio to the display-side controller and, for the AV art piece or a selected audio play one code, downloads the display link (linking substantially simultaneous art display with the audio broadcast), and if an AV art piece is being played with another user-selected audio track, the audio override code or command. The streaming controller also downloading the temporal play command for the artwork selection and the audio override for the AV art piece display link.

Another object of the present invention includes a data structure enabling the display-side controller to engage the user's viewing display and the acoustic player to present the artwork and audio in compliance with: the temporal play command (e.g., how long the art will be displayed with the audio track), and, in the presence of the audio override the selected audio.

It is a further object of the present invention to provide a data structure wherein a sub-plurality or group of VA visual art pieces and AV art pieces are either best presented in a portrait-format (the same being coded or tagged with a portrait-format code) or presented in a landscape-format (having a landscape-format code). When the user's selected VA or AV play one includes a portrait-format code or a landscape-format code, the streaming controller downloads, to the display-side controller, the portrait-format code code or and the landscape-format code code. In the presence of the portrait-format code or landscape-format code, the display-side controller adjusts the presentation on the user's view display monitor for the portrait view or the landscape view. These portrait/landscape format codes may be add-on meta data that is associated with the artwork or may be embedded into the electronic NTSC, PAL, SECAM video streams or the video streams driving multiple-sync (multi-sync) monitors, also known as a multi-scan or multimode monitors.

Another object of the present invention includes a data structure wherein the user's viewing display monitor is attached to a mechanical rotational positioner controlled by the display-side controller. This controller commanding the rotational positioner, rotates the view display to either a portrait portrayal or a landscape portrayal in the presence of the portrait-format code or the landscape-format code. This rotation of the view display being either prior to or during the presentation of the VA or AV art pieces.

Another objective of the data structure, for the VA or AV play one selection, includes storing the artwork selection and the selected play one in the UPP (this data obtained from the display-side controller), and also accepting, from this controller, a user artwork playlist representing a plurality of artwork selections to be displayed in a sequential display order on the view display. The artwork playlist is stored in the UPP. An additional objective of the present invention is to have a temporal play command which includes one playtime command or code from the group of playtimes including a single distinctive per-artwork playtime, a uniform per-artwork playtime, a per-playlist playtime, a repeat playtime, and a random playtime.

Further objects of the present invention involve a data structure wherein each artwork selection has a corresponding datastore address (because the artwork is stored in other databases or datastores). Also, the artwork playlist (the sequential play of art) is a list of datastore addresses. These addresses are stored in the UPP. In this manner, the UPP database or datastore has less data therein (and becomes more efficient), and the user can select and deselect individual artwork and/or repeat one or more playlists as he or she desires. The same data structure is used for the VA datastores, AV datastores and audio datastores.

The efficiency of the improved data structure is an important feature of the present invention. One efficiency uses datastore addresses stored in the user personal profile (UPP) to enable quick access of the artwork databases by the streaming server. In contrast, current prior art accesses a single artworks or art piece without the ability for a user to pre-program an art playlist for sequential presentation of artworks. The UPP can have pointer or links to audio databases, to NFT datastores (which NFTs hold access links or pointers to off-chain art stores), and to multiple, different art stores. All this efficiency is embodied in the UPP and streaming server. TO this effect, the user can collect art as he or she sees fits, group them into art playlists and display them as he or she sees fit with temporal time-based controls. This improved art data structure avoids the current problem users experience in having to switch APP channels to locate one AV artwork (whether a movie or a series of episodic shows), and then, switch APP channel to see other AV shows. The present data structure permits the user to build up an artwork collection with sequential playlists and temporal to watch the art as he or she desires. From the artist's standpoint, the present system is more efficient because in an NFT setting, the artist can control his or her art via digital rights management DRM controls.

It is an important object of the present invention to provide a more efficient and improved artwork distribution system and data structure to locate, curate, organize and distribute the artwork to the end-user, consumer. The end user has control settings to set the playlist art and the playlist sequence with temporal controls. The system enables an efficient access to artworks in various databases, including but not limited to NFT datastores. The present invention improves presentation of the artwork with the portrait/landscape controls, which controls are not currently known in conjunction with playlist generated and displayed artworks. Further, pre-formatted NFTs are more efficient for the artist since he or she can simply drop the art into the pre-formed NFT with an understanding of monetary recovery based upon display and usage of his or her art. Further, the use of a distributed autonomous organization (DAO) enables a more efficient artwork distribution system because the DAO can engage a collective human response to unpredictable events.

To enhance efficiency of the data structure, each artwork selection has a corresponding datastore address and, in a similar manner, the artwork playlist is a list of datastore addresses. These addresses are stored in the UPP for quick access to the selected artwork by the streaming controller.

It is also an object of the present invention to provide a data structure wherein the artwork datastore is a nonfungible token (NFT) datastore. In other words, the VA or AV artwork is stored either on-chain NFT datastore (in the NFT blockchain itself) or off-chain NFT datastore-blockchain. Typically, artwork is stored off-chain in an IPFS datastore. In the off-chain storage, the NFT artwork-access token provides an access control link to the IPFS-stored artwork. The user's UPP includes the user's NFT access codes or commands, which are generally referred to as the user's id. When the streaming controller obtains and accepts the selected VA or AV play one (which also may be the audio play one) the user's UPP id must match or correspond/correlate to the user's NFT access codes or commands. In this manner, that controller can access the NFT-stored artwork (or the NFT link to the off-chain stored artwork) and download the art based on the VA or AV play one or audio play one commands and in accordance with the temporal play controls.

An enhancement of the present invention operates a data structure wherein the user may, via the display-side controller, setup and process a user autoplay command. Once the data structure is initialized, that is, pre-programmed, the user autoplay command is triggered by one of a time-of-day event (for example, “display artwork 1 between 7-8 AM, M-F) and a detected ambient environmental condition (for example, when the front door opens, display artwork 2 and play audio 1). The triggered selected play one is stored in the UPP. The display-side controller responds to the time-of-day event (for example, this controller may have a time clock and an alarm setting) and the detected ambient environmental condition and auto-generates and sends the user autoplay command to the streaming controller. The streaming controller, in the presence of the user autoplay command, downloads the temporal play command and the triggered selected VA or AV play one artwork selection, and if encompassed in the autoplay command, the audio selection play one. In order for the display-side controller to detect the ambient environmental condition, the display-side controller is coupled to ambient environmental condition sensors, such as door open sensors, dog barking sensors, daylight sensors, person-walking-through-doorway sensors, etc. Prior art systems couple various ambient environmental condition sensors to other computer-based devices. The present invention improves upon data structures and methods with coordinated AV and VA and sometimes audio displays and broadcasts.

The improved data structure uses transcoding to download the user's artwork play one selection. Also, the artwork may include encoded digital rights management (DRM) commands or code limiting display or aural play. The DRM encoding may be embedded in the artwork in the datastores or the DRM may be stored in the user's UPP (on the streaming controller side of the data structure). In any event, the display-side controller reacts and follows the DRM play/display limitations and the artwork or audio is so display/play limited on the user's viewing monitor and acoustic player.

In connection with NFT-based artwork storage systems, further objects of the present invention involve a data structure which includes a smart contract (SM) in one SM block of the linked NFT blockchain. The SM includes DRM display controls, Upon access to this NFT configuration, the DRM encoding is obtained from the NFT with the NFT access codes for the off-chain artwork datastore. The encoded DRM commands are downloaded with the play one artwork selection to the display-side controller and decoded by that controller. This controller limits display/play in accordance with the DRM associated with the artwork and the audio track or data file. Alternatively, the DRM may be responded to (decoded) by the streaming controller, and that streaming controller then generates complementary display/play commands to the display-side controller. The DRM encoding may have DRM download actions including: a time-limited teaser play of a portion of the artwork selection, a single play of the artwork selection, and a one-play-of-n-plays control for the artwork selection. To improve efficiency of the data structure, the DRM data/commands are stored with the selected VA or AV play one and the associated artwork selection in the UPP. This UPP datastore or database is coupled to the streaming controller to improve efficient selection and distribution of artwork and, in some cases, audio data files. The DRM commands, via the display-side controller, alter presentation of the artwork selection on the view display. As indicated earlier, the DRM may be located in the NFT-based artwork datastores.

It is a further object of the present invention to provide a data structure wherein a smart contract (SM) in one SM block of the NFT-based art stores (the NFT being a linked blockchain) includes DRM display controls. These DRM display controls may include, among others, a one-play-only play-code or a no-play-code. The data structure further includes a distributed autonomous organization (DAO) blockchain (the DAO blockchain can be configured as or with distributed ledger or DLT data structures, and as such, DAO blockchain is a distributed ledger data structure). The DAO blockchain includes a smart DAO contract (SDAO) in a linked DAO cell forming the DAO blockchain or DLT structure. The SDAO generates an approved access code to the SM on the NFT art-carrying blockchain and, upon an execution output from the SDAO, and the NFT SM generates the play-code upon receipt of the SDAO approved access code. In the absence of the SDAO approved access code, that is the no-play code, the streaming controller cannot access and obtain the NFT-controlled artwork. Alternatively, the display-side controller may have limited play commands originating from the SDAO. The DRM encoding added to the data structure includes equivalent DRM download action commands including: a time-limited teaser play of a portion of the artwork selection, a single play of the artwork selection, and a one-play-of-n-plays control for the artwork selection.

The above-described data structures and process flow methodologies establish an artwork selection and display/play system with is highly efficient, easily expanded to couple many, many artwork datastores and audio datastores to the steaming controller (and the companion steaming controller database or datastore holding UPPs for innumerable customers), to enable the user to browse through art collections, add audio tracks to play during the substantially simultaneous art display, to enable the user to compile art playlists, and to enable the user to alter the audio track of AV artwork and add his or her own audio track to the play/display. The efficiency of the data structure also is based upon storing pointers to the artwork data in the UPP rather than storing the art itself in the UPP database or datastore. These pointers are access pointers, such URL addresses, to the artwork in the artwork datastores. The further inclusion of DRM controls implemented at the streaming controller/server side (and processed and applied by the display-side controller) also increases the selection and display of the artwork and linked audio files. The NFT-based artwork datastores provide (a) greater access to artwork, (b) provide additional control elements and options to system operator with the use of DRM controlled play-display, and needed pathways to renumerate content creators (that is the VA and AV artists). With the DAO organizational blockchain or DLT data structure, master display/play commands can be implemented to achieve a high degree of overall efficiency in the selection of artwork by the user.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described below, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, unless otherwise specified terms such as “first”, “second”, “third” and so on are only used for descriptive purposes, and cannot be construed as indicating or implying relative importance. In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. The terms “program,” “software application,” APP, and the like as used herein, are defined as a sequence of instructions designed for execution on a computer system. A “program,” “computer program,” or “software application” or APP may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

Further objects and advantages of the present can be found in the detailed description when taken in conjunction with the accompanying drawings. Similar numerals designate similar items throughout the drawings. Like reference numerals also refer to identical or functionally similar elements throughout the separate views and which together with the detailed description below are incorporated in and form part of the specification, and serve to further illustrate various embodiments and explain various principles and advantages all in accordance with the present invention.

FIG. 1 is a diagrammatically illustrates the streaming data structure enabling user controlled download of artwork, and potentially audio tracks, and viewing of the artwork as well as acoustic presentation of audio. FIG. 1 diagrammatically illustrates both the system and the process in accordance with the principles of the invention.

FIG. 2 is a diagrammatic flowchart showing user controls and user selection of contents as well as content display time (Dtime). FIG. 2 diagrammatically illustrates a user control—user display time flowchart.

FIG. 3 diagrammatically shows display of multiple artworks, in a playlist sequence, with display framing control signals for presentations playlist D1 and playlist D2. FIG. 3 diagrammatically shows the customer display 1D1 (for customer 1, display artwork in sequence 1)(“seq 1”), 1D2 (customer 1, display art seq 2) frame examples as a timing diagram for two content sequences 1D1 and 1D2 associated with customer 1.

FIG. 4 diagrammatically illustrates the system and the method for orienting artwork streamed to a viewing display and reorienting the artwork prior to display to either a portrait formatted presentation or a landscape formatted presentation.

FIG. 5 diagrammatically shows the streaming process and control process by and end user.

FIG. 6 diagrammatically illustrates nonfungible token (NFT) accessible artwork (off-chain art on IPFS).

FIGS. 7A and 7B diagrammatically illustrate two data structures wherein FIG. 7A shows, in connection with nonfungible token Cnft 002 (customer NFT (Cnft) token owner 002 of many n token owners, “n” being the token cell or block) access to an off-chain artwork datastore IPFS retaining the art and, in connection with NFT token Cnft001, access to a 2^{nd} NFT blockchain which holds a group of art pieces Cnft-GRP 001 which art pieces are ultimately downloaded to the user's viewable display. FIG. 7B diagrammatically shows that the NFT blockchain holds or contains a point or an access link to a collection or group of art pieces in token GRP 001, permitting access to multiple art pieces in an off-chain datastore IPFS.

FIG. 8 diagrammatically illustrates integration of an NFT having access to art pieces, the tokenization for those art, ownership characteristics, royalty management systems through a digital rights manager or management (DRM), and the various software tools and processes for the streaming artwork.

FIG. 9 diagrammatically illustrates distribution and markets segmentation for the user controllable AV-artwork steaming data structure with conjunctive configurable NFTs wherein NFT blockchain systems can be used to publish in distribute artwork.

FIG. 10 diagrammatically shows further conjunctive configurable NFTs including token coin generation.

FIG. 11 diagrammatically illustrates one method, process and data structure having and organizational structure involving a distributed autonomous organization (DAO) to control the conjunctive configurable art NFTs including token coin generation, royalty payments through smart contracts on the blockchain.

FIG. 12 diagrammatically illustrates a high-level structure for the conjunctive configurable art NFTs including trading marketplaces and enforcement processes.

### DETAILED DESCRIPTION

The present invention relates to a user controllable artwork and/or AV artwork which artwork is streamed to a user viewing display and, for AV artworks, the view display is coupled to an audio acoustic player. The data structure, system, and method operates in conjunction with artwork datastores (visual works and AV works), and in some situations, and audio datastore which enables display of the artwork plus a user selected audio track. The artwork may be stored or accessed through a non-fungible token (NFT) blockchain. An abbreviations table at the end of the specification provides additional explanation of the items shown in Figures.

In summary, the present invention permits the user who views these audio-visual AV displays to select the content, select the repetition of the content, select the display format (portrait or landscape) and select content from several different databases or online sources. The final product is a playlist wherein the System Operator (Sys Op) Server (identified in the drawings as Blkd Svr) (the server carrying programs as described herein), loads artwork frame controls (a temporal time-of-display control—command) onto the user's controllable display or display-side controller (the display controller having some memory and processor for accepting these format commands and altering the presentations on the display as needed or commanded), and the downloaded content from various content servers (Cnt Svr) is played on the user's viewable display in accordance with the framing controls. The present invention establishes and permits the user to compile a playlist wherein the user selects the repetition of each art piece and/or audiovisual content (a selected (sel) “repeat” frame control), the total duration of play for each audiovisual or static visual art content (a sel per-art-piece duration frame control or timeframe), and select different content from different content suppliers (a sel content (Cnt) control). Financially, artists can be compensated for permitting the central control system (herein the Blkd Svr) of the present invention to affect the downloading of the visual artwork or short form video clips and the static visual images from one or another content sever (Cnt Svr). Additionally, as an expansion of the present controller system, the user may select musical compositions (an audio track) to be played with any particular static visual art image. For AV artwork, if the user wishes to listen to a different audio track, the system generates an override commend instructing the display-side controller to play the selected audio track for the visual portion of the AV artwork via the acoustic player or speaker system.

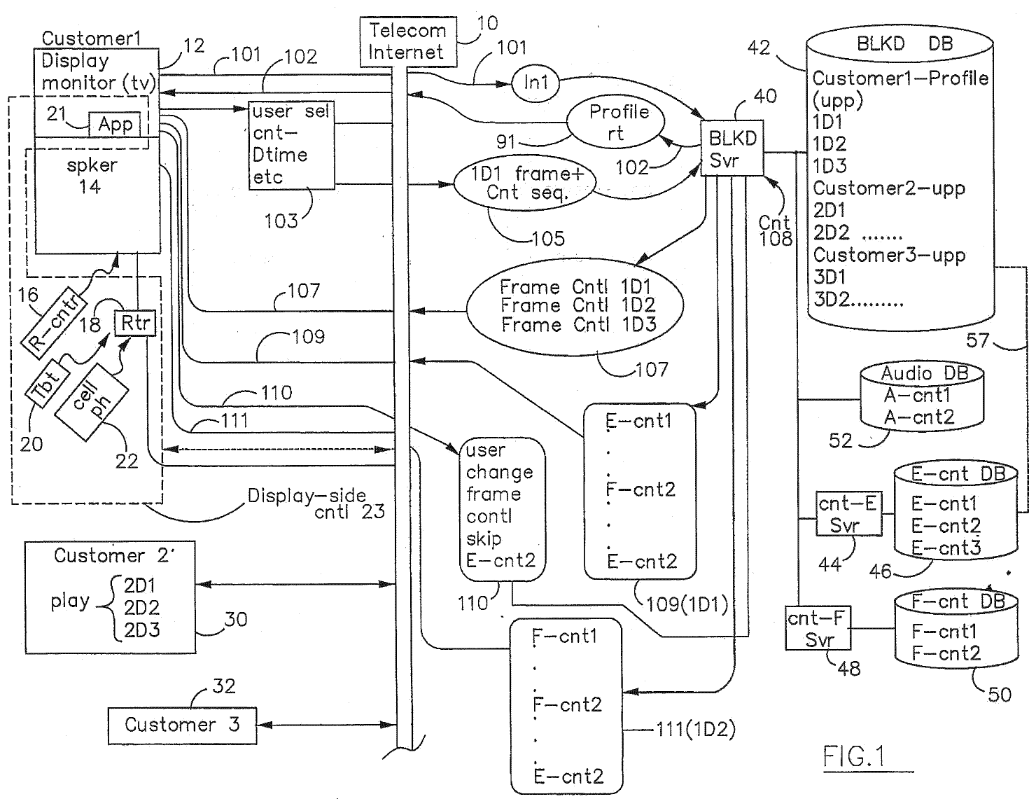

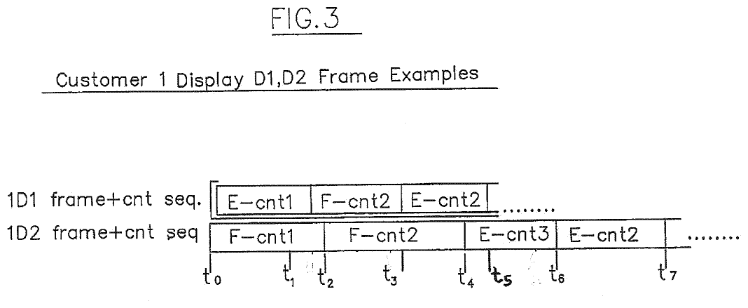

FIG. 1 a diagrammatically illustrates the streaming data structure enabling user-controlled download of artwork, and potentially audio tracks, and viewing of the artwork as well as acoustic presentation of audio. FIG. 1 shows the system as including a viewable display monitor or television 12 for Customer 1 (C1). Customer 1's monitor also includes a speaker 14 (an acoustic player or announcing system) for presenting the audio track of the content Cnt displayed on the display monitor. As discussed below, the display-side (DS) controller 23 (shown in dashed lines) which controls the display of artwork on monitor 12, can be configured using various hardware and software functions. Customer 1 has various control options such as a remote control 16 (R-cntr) for the display monitor or TV 12, a tablet computer 20 (Tbt) and a cell phone 22 (cell ph). DS controller 23 may include computer-based hardware, such as tablet computer 20, cell phone 22, smart TV with App 21 (shown as installed on the TV but is also installed on the phone or computer). APP 21 can be activated by the remote control 16 for the display monitor. Of course, the remote control 16 for the display monitor 12 can also control the volume and, in other aspects, the volume of the audio track played on the acoustic speaker. The user or Customer 1 activates the APP and the tablet, cell phone, STB, or Roku-type device communicates with a router 18 (Rtr) as does the display monitor 12 through the APP. The router Rtr is coupled to a telecommunications network or the internet 10. The DS controller 23 is also coupled to the internet. The view display monitor as a smart TV is locally controlled by a processor coupled to the display and programs locally stored in a memory. Sometimes a set top box (STB) (not shown) can be programmed to control the display 12. Other times a ROKU®-like controller controls the display. Effectively, DS controller is a media player. The DS controller can operate as a streaming portal receiving data from server 40 or can act in a forward-and-store player which remotely retains the artwork playlist, temporal controls and the portrait/landscape controls. Also, telecom and internet 10 represents cable, over-the-air telecommunications systems. Although the UPP stores the selected play one art piece and the associated temporal play command and the DS controller enables presentation on the view display 12 in compliance with the temporal play commands (see FIG. 3, frame timings tl through t7 for playlist 1D1 and playlist 1D2), all based upon an art play command, the downloading of artwork can be in real time or in a forward-and-store mode. Hence, streaming controller 40, upon the art play command, either (a) substantially contemporaneous with the art play downloads the artwork selections and temporal play commands to the display-side controller or (b) prior to the art play command, has been downloaded the artwork selections and temporal play commands to the DS controller.

These display controls, tablet computer APP, cell phone carry an APP, smart TV APP, STB and ROKU®-like controller, are generically and collectively referred to as the display-side DS controller 23. The display-side controller, in a similar manner to the above identified hardware systems, includes a user actuatable interface to enable the user to activate certain commands to control the view display or monitor. Typical user actuatable interfaces include keypads on remote control or ROKU®-like controller, sometimes in combination with and alphanumeric display on the view display monitor. The display-side controller 23 may also control the acoustic speaker system. The display-side controller, regardless of specific hardware mentioned above, enables user to carry out functions diagrammatically illustrated in FIG. 1, including uploading system and user personal profile (UPP) initialization step or function 101. Customer 2 (in block 30) and customer 3 (in block 32) also have the display-side controller and the view display monitor 12.

This hardware is communicatively coupled via internet 10 to the Sys Op server or Blkd Svr 40, which in turn is coupled to a database, Blkd DB 42. As explained later, server 40 is also communicatively coupled to artwork servers and databases identified as Cnt-E server 44, E-cnt DB 46, Cont-F Svr 48 and F-cnt DB 50. Additionally, an audio DB 52 is coupled to Blkd Svr 40. Server 40 uses API to access artwork and audio in remote datastores, including NFTs as discussed below.

Operationally, once the user or customer initiates communication with Sys Op Server 40, the server downloads UPP profile data as needed for initializing the display-side controller (in real-time (RT)) function 91 or step 102. The initialize request In 1 is sent to the Blkd Svr 40 in step 101. Once initialized, the display-side controller is used as a user content Cnt selection tool and a content playtime frame control (display time “Dtime” for the content “Cnt”) as a temporal control command function 103, and transmission of a content Cnt selection, frame control commands and content sequence 1D1 function 105 to server 40.

In summary, server 40 then downloads content and frame controls in content function or step 107, downloads supplemental content in function 109 (sequentially Cnt E content, then Cnt F content, then Cnt E content, a sequential presentation of artwork on the view display 12), downloads user selected temporal frame controls and other content control function 110, and further downloads in function 111 different content F-Cntl from artwork database F, F-Cnt 2 from database F, and E-Cnt 2 from database E.

To initialized system, the user, customer 1, uploads sufficient data to identify the customer and inputs the data into Blkd database (DB) one. Server 40 provides a template for the new data from the customer. Alternatively, the customer may complete an online form vis his or her computer to set up the UPP in Blkd DB 42. Additionally, the display-side controller identifier is stored in the system operator Blkd database. The router Rtr 18 identifier for customer 1 may also be stored in the UPP.

As part of the request to play artwork (in step 101, “In1”), customer 1 will identify content to be played on the display. Content may be stored on the system operator DB 42 or may be stored on other artwork databases E (DB 46) and F (DB 50) shown in FIG. 1. Customer 1 is identified as “1D,” whereas customer 2 is identified as “2D,” and customer 3 is identified as “3D.”

In a similar manner to customer C1, customer 2 (C2) has similar display-side controller equipment which permits customer 2 to display artwork with various temporal or time-based frame-controlled content sequences discussed later in connection with customer 1. Customer 2 display sequences are identified as 2D1, 2D2 and 2D3. Customer 2 is also connected to the telecommunications network or the Internet. Customer 3 has a similar monitor or viewer and content and frame-temporal controls to play different content.

Effectively, the content is downloaded to customer 1 through the router or display-side controller 23 and to the display monitor 12 and speaker 14 by the Blkd server or Blkd Svr. The Blkd Svr is also called a distributive streaming controller. Other servers may be used to control temporal time-based framing and content download to the customer. This distributive streaming controller (herein the Blkd server) is connected to a Blkd database 42 (Blkd DB) which has the UPP profiles for customer 1, customer 2 and customer 3. These profiles, sometimes called a user personal profile (UPP), contain various information regarding the customer including financial information relating to the display of artistic content downloaded from the server Blkd Svr to the customer display monitor, the IP address of the customer (associated with customer 1 router and possibly the display-side controller), and other playlists and control settings for the display. The streaming controller, Blkd server 40 plus Blkd database 42 (Blkd DB) may also include the artwork database 46 (E-cont DB). In such combination, E-cnt DB 46 may omit the associated E-cnt server 44. In other words, BlkD DB 42 may include an artwork database. See dashed line 57 coupling DB 46 to BD 42.

The playlists for customer 1 are initially 1D1, 1D2, 1D3 (step 107), and then E-cnt1, F-cnt2, and E-cnt 2 (step 109), and then finally F-cnt1, F-cnt2 and E-cnt2 (step 111). It should be appreciated that customer 1 may have several display monitors throughout his or her home or business. Each display is tracked by a unique display id-code such that different artwork displays may present different images or clips on the different monitors as programmed by the user.

The Blkd Svr server 40 is also connected to content server E 44 (CNT—E SVR), and content server F 48 (CNT— F SVR). Blkd Server 40 may also receive or obtain content from other sources in step 108. Content server E 44 is connected to content database 46, E— CNT DB which contains E content 1, E content 2 and E content 3. Content server F 48 is connected to F— CNT DB 50 which contains content F— CNT 1 and content F— CNT 2. Content server E and content server F are coupled through a telecommunications or Internet network to the distributive streaming controller Blkd Svr server 40. As indicated in FIG. 1, the content flow 108 to Blkd Svr is supplied by other content servers, in addition to content servers E and F. The Blkd Svr then downloads the content to the user's display as commanded by the user. Reference herein to a streaming controller is not meant to encompass the type of artwork download to the display-side controller. In other words, the streaming controller could (a) download all artwork to the display-side controller (DS controller) such that the DS controller retains in its memory all the selected artwork (similar to a set top box STB with a DVR or other memory unit); or (b) stream the artwork in real time to the DS controller; or (c) engage in interment downloads of artwork given the bandwidth of the communication channel and the memory in the DS controller. Stated otherwise, the artwork need not be streamed in a continuous manner from server Blkd 40.

To initialize the UPP in Blkd Svr and Blkd DB, customer 1 must complete the UPP form provided by the Blkd Svr to generate a basic user profile. After the creation of the base UPP profile, in order to select and control the content, customer 1, in process 101, initializes the APP and communicates with the Blkd Svr server. The APP is stored on the local memory for the display-side controller and the local processor in the display-side controller executes the APP program to communicate with the Blkd Svr. The Blkd Svr, in process 102, returns a playlist to Customer C1 to enable the user to select one or another of the pre-programmed content sequences from the artwork playlist. These content sequences (which include control framing commands (cmd) as discussed below) have been previously stored by the customer in his or her UPP. Of course, the user may build a playlist with interactions with the Blkd Svr (building a playlist is known in the audio art (see Spotify®) although not a playlist for art with framing temporal controls for each artwork piece). Also, the Sys Op or Sys Admin may create and distribute artwork playlists which the user can select at his or her own leisure. These system-prepared artwork playlists can have digital right management DRM play controls embedded in the playlist such that the user can only play the playlist once or twice, and then must purchase access to the system-prepared artwork playlist.

The playlists (pre-programmed at initialization or re-initialization per the user) are obtained from customer 1 profile (C1 UPP) from Blkd DB and delivered to the user's display-side DS controller 23 in real time (RT) to the customer's display monitor (more properly, to the display's memory and processor) via streaming server Blkd Svr. This is one embodiment of the invention. Another embodiment of the invention engages the server 40 to download the artwork selections listed in the art playlist to the DS controller's memory (for example, when the DS controller has a DVR memory store). In this manner, the playlist is immediately available but the temporal controls still operate the display of the art. Access to the UPP profile enables customer 1 to select a pre-existing playlist discussed later in connection with FIG. 3.

As indicated earlier, artwork datastores (Blkd DB, E-cnt DB, and F-cnt DB) can retain visual artwork and AV artwork. “Visual artwork” may also include a number of visual artwork pieces stored sequentially. The same is to regarding AV artwork. FIG. 1 also shows and audio database, Audio DB, having digital representations of audio clips or entire musical scores. Therefore, A-cnt1 is a different audio track than A-cnt2.

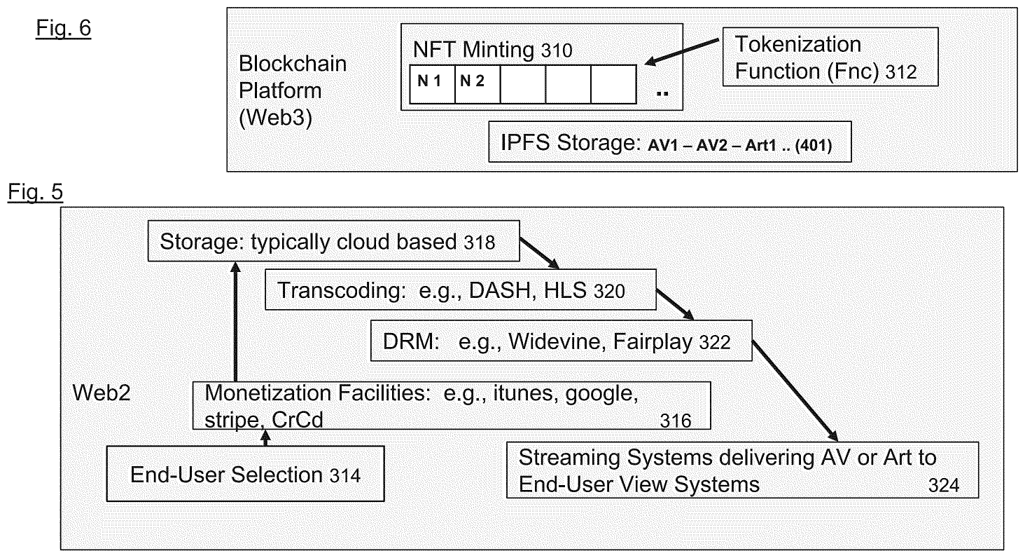

FIG. 1 shows an example of the process for the user controllable AV-artwork steaming data structure. There are artwork datastores Blkd DB, E-cnt DB and F-cnt DB, which store digital versions of artwork (cnt1, cnt2, cnt3, with prefixes E and F and sometimes noted without such prefixes). An artwork collection is a plurality of discrete visual art pieces (cnt1 is different than cnt2) and a plurality of discrete AV art pieces (cnt1 may be visual static art and cnt3 may be AV artwork). Datastores may refer to several databases of other digital collections. The datastore may be cloud-based or as explained later the datastore may be an on-chain non-fungible token (NFT) datastore or an off-chain NFT datastore. See FIG. 6, for example. Also, the Audio DB is an audio datastore with a plurality of discrete audio pieces, A-cnt1, etc.

The user is provided with a user view display or monitor, and an acoustic player or speaker 14. The view display permits the user to display the artwork and the acoustic player permits an audio presentation of the AV art pieces and the audio pieces, A-cnt1, 2, 3. The display-side controller, shown in the dashed line 23, may be a singular special purpose STB, with or without memory (e.g., a DVR), a ROKU®-type device, a combination of APPs on the smart TV, a tablet, a cell phone, etc. which are operative to control the view display 12 and the acoustic player or specker 14. As an example, the user can download and APP from server 40 on the user's cell phone, select pre-programmed artwork playlists on APP, then pair the cell phone with the living room smart TV (or other BlueTooth™ enabled STB-type controller), initiate a playlist art play command on the cell phone, go into the bedroom, selected a different playlist for the bedroom, pair the cell phone to the bedroom TV/STB-controller, and play a different playlist in the bedroom. The efficiency of this select-art, engage the DS controller, initiate play-art command, download artwork data structure is an important aspect of the present invention.

The streaming controller Blkd svr, or a system operator server is communicatively coupled to the display-side controller and accesses artwork from the artwork datastores (Blkd DB, E-cnt DB; F-cnt DB) and audio data from the audio datastore (Audio DB). APIs link server 40 to databases 42, 46, 50. Although the user initiates the action, the Blkd Svr accepts the user's artwork selection in step 105 for a selected play one visual art piece or AV art piece (content 1D1). The server also accepts user-initiated temporal play command (the frame+Cnt sequence data command) in connection with the selected play one from the display-side controller.

The server also accepts a user audio selection in step 105 (not shown in step 105 but implied for selection of A-cnt1, etc.) for a selected audio play one audio piece from the Audio DB. To play the selected visual art 1D1 with the selected audio play one (A-cnt1), a display link command is generated by the Sys Op server associating the decreet artwork (or series of play-linked artwork, see series 1D1, 1D2, 1D3) with the audio file A-cnt1. The display link command is sent by the Sys Op server Blkd Svr along with the discreet artwork and the audio file to the display-side controller in step 107. If the discreet artwork is an AV file, in addition to the display link command, the Blkd Svr generates an audio override command, instructing the display-side controller NOT to play the audio portion of the AV artwork but instead to acoustically play the selected audio file when the selected visual artwork is displayed. The Sys Op server detects the type of artwork, visual art VA vs. AV art, and if the user selects an audio file to simultaneously play with the visual art, generates the display link in all situations and in the AV art situation, also generates the override command. If the user has created a playlist in initialization step 101, then the display link and the override command is stored in the UPP to reduce compilation times. These compilation times to combine audio file downloads with artwork downloads is effected by the interposed communications channels between the Sys Op server and the various art and audio databases.

To the effect that the streaming controller, upon the user-actuated art play command from the display-side controller, obtains the artwork selection(s) from the artwork datastore(s) and obtains the audio selection(s) from the audio datastore, and downloads the artwork selection and the audio selection to the display-side controller in addition to the display link, and if needed the audio override. The display link is needed with all audio file downloads to link or associate an artwork with an audio file. Of courses, the user can compile many artworks in an art playlist and have the audio track played while the entire artwork sequence is displayed on the user's view display monitor. The result being that the display-side controller enables presentation, on the view display monitor and, if selected the acoustic player, in compliance with the temporal play command (that is, the frame time-based playtime): (i) the artwork and audio selection and (ii) in the presence of the audio override, the artwork selection and, substantially simultaneously, the audio selection.

As indicated earlier, the UPP stores the artwork selection, the selected play one command from the user (see step 105), the temporal play command (“frame”, step 105), the audio selection for A-cnt1, the selected audio play one (the uploaded suer command to play the audio), the display link between the art and the audio, and for AV art pieces, the display link and the audio override.

FIG. 3 shows two different playlists for different content, that is, Customer 1 artwork display sequence 1D1 which includes framing controls (time-based temporal “frame” controls) and different content (artwork sequence cnt seq.) in a pre-programmed content sequence from Content servers E and F in FIG. 1. The content sequence for Customer 1, display 1 includes E content 1 (E-CNT 1); F content 2 (F-cnt 2); and E content 2 (E-cnt2). E content 1 is played between time T0 and T-1; F content 2 is played between time T-1 and T3; and E content 2 is played between time T3 and T5. In contrast to the 1D1 play sequence, Customer 1 artwork display playlist 2 (1D2) has framing and content sequencing as follows. Content F— CNT 1 is play between times T0 and T2; content F has play times between times T2 and T4; content E3 has play times between times T4 and T6, and content E 2 plays between times T6 and T7. Further, during the timeframe between T4 and T6, the second display sequence list 1D2, includes a 3X repetition of E— CNT 3 during the timeframe T4-T6. This is the repeat temporal command. Static image artwork displays only need start time T0 and end time T2.

Returning to FIG. 1 and process step 103, the user selects the content from a pre-programmed playlist (e.g., 1D1 or 1D2 or 1D3) and the display time (D time) as he or she wishes. Step 103 involves interaction with the display-side (DS) controller. In process step 105 (which is part of step 103), the user (C1) has selected a certain item from his or her playlist, which is a select command (Sel cmd)(an artwork selection), and the Sel cmd (a selected play one) is sent to the server requesting that the server tee-up and prepare to play customer 1, display content 1D1 frame and content sequence. As an example of artwork stored in a database other than in the Blkd DB, when the selection cmd is applied to the Blkd Svr, the server in accordance with 1D1 frame and content sequence cmd, obtains from content from the E database (E CNT 1) via the E server content 1, and obtains via the content F server and the F-cnt DB the F CNT 2 artwork or AV artwork. Alternatively, Blkd DB 42 may include, in addition to the UPP, artwork database E-cnt 46 as shown by the dashed coupling line 57. The Blkd Svr further obtains relevant and requested content from content servers E and F. The Blkd server may coordinate with the relevant content servers to effect the download of the content ultimately to the user's display. The framing control data is obtained from the user's UPP, associated with the respective playlist designator in the Blkd DB for this playlist. Alternatively, if the display-side controller has adequate memory and processing power and speed, the framing controls may be held and applied by the display-side controller. However, long play AV artwork or high video density visual artwork storage may limit the local storage and processing of framing temporal commands on stored artwork on the display-side controller.

In this manner wherein Blkd Svr applies the frame control to the artwork, the user selects framing data commands which include how long a particular visual art content (a video clip or a static two-dimensional visual display) is displayed on his or her view display monitor, the repetition of the display of a video clip or static visual art piece, the total time the video clip or static visual display is displayed on the customers display monitor (a single play or a multiple play framing cmd), and the sequence for this video art (VA) and the sequence of different video art (VA) content to be displayed in accordance with a particular playlist.

Once the user in process step 105 identifies or selects the playlist (which selection ultimately determines the framing instructions for the content 1D1 as well as the content sequence for 1D1 (as well as 1D2 sequence)), this Sel instruction 105 is presented to the Blkd Svr. Sometimes, the customer may create the playlist on the fly and sometimes the customer will save his or her playlist in the UPP. For on-the-fly creation, the customer will be presented with samples of available artwork (each sample possibly watermarked SAMPLE or otherwise marked), arrange for payment of each NFT-based artwork, compile the new playlist, and either play the playlist at that time or save the playlist for future use. The playlist may include video clips (AV), static video images (VA) and other video art (artwork having motion but without an audio track) to be displayed on the monitor. Sometimes the user will build a playlist from samples presented to the user from Blkd Svr (which may include samples of content from the content servers). The Blkd Svr may watermark the VA samples prior to display to the user. The data structure establishes an efficient process to sample artwork (directly or via NFT-based artwork), build an artwork playlist, create unique audio tracks to be played with the artwork playlist (or separately with the single artwork). In one embodiment, when the DS controller is an APP on the user's cell phone, the memory on the cell phone may be sufficient to store an entire art playlist in a forward-and-store configuration. In this manner, the user whenever he or she wants to see the art on a large TV or monitor, can simply pair the cell phone via BlueTooth™ with the TV/monitor, and engage the play-now command to see the work. In the forward-and-store configuration, all the temporal controls and the portrait/landscape controls are stored in the cell phone as the DS controller, and access to the internet is not needed. This explains an efficient data structure for accessing and displaying artwork.

An additional feature in connection with static video or visual images is that the user can select to display the art in a landscape mode or a portrait mode. This portrait/landscape setting for static visual art images is also saved in the customer UPP associated with the particular content. Stated otherwise, the content obtained from Content Servers E, F may have different display frame formats. The user, in this invention, can change the display of E CNT 1, E CNT 2, F CNT 1, etc., as he or she wishes or, alternatively, the artwork may have embedded therein encoded portrait/landscape data.

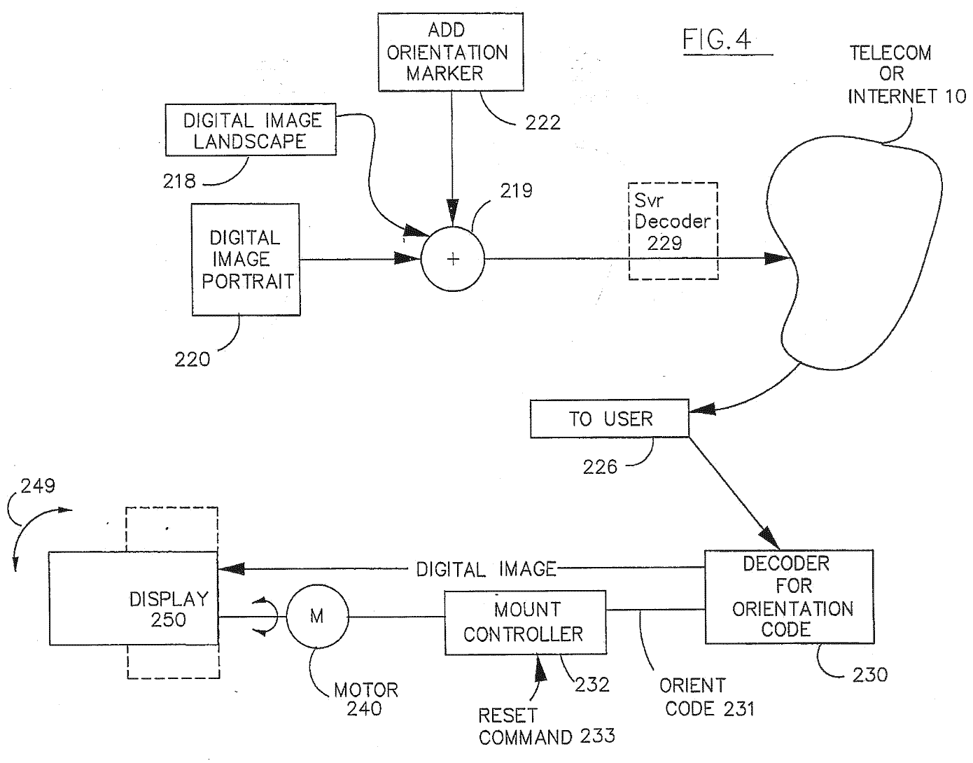

FIG. 4 diagrammatically illustrates the system and the method for orienting artwork streamed to a viewing display and reorienting the artwork prior to display to either a portrait formatted presentation or a landscape formatted presentation. Certain discrete visual art pieces and discrete AV art pieces include either a portrait-format code (artwork 220) or a landscape-format code (artwork 218). The portrait-format code and the landscape-format code for the respective discrete visual art pieces and respective AV art pieces being stored either in the artwork datastore (see FIG. 1, E-cnt DB or F-cnt DB) or in the Blkd DB. When the selected play one artwork (see step 105, FIG. 1, 1D1 artwork sequence) includes a corresponding portrait-format code or landscape-format code, the streaming controller Blkd Svr downloads to the display-side controller the corresponding portrait-format code or landscape-format code with the artwork selection. In the presence of the portrait-format code or landscape-format code, the display-side controller adjusts the view display monitor for (i) a portrait view display in the presence of the portrait-format code and (ii) a landscape view display in the presence of the landscape-format code. These portrait/landscape format codes may be add-on meta data that is associated with the artwork or may be embedded into the electronic NTSC, PAL, SECAM video streams or the video streams driving multiple-sync (multi-sync) monitors, also known as a multi-scan or multimode monitors. Server 40 may add on the portrait/landscape format codes to the artwork on the fly or may process artwork prior to downloading the artwork to the display-side controller by detecting the portrait/landscape format of the art by image analysis, and then associating the appropriate portrait/landscape format code to the art. Alternatively, server 40, in conjunction with DB 42, could retain an artwork title or access indication (e.g., a URL to the DB 46, 50) and DB 42 could link the specific portrait/landscape format code to the specific artwork. In this manner, once DB 42 has the format code associated with some artwork indicator (or, if DB 42 is combined with DB 46, see dashed line 57, stored with the artwork), and once the artwork is called up to be displayed, the portrait/landscape format code travels with the artwork to the display-side controller. Alternatively, if the artwork is earlier downloaded to the display-side controller prior to the art play command or the selected play one, the portrait/landscape format code is sent to the DS controller at that time.

Once the portrait/landscape format codes are either embedded with or associated with the specific artwork, the display-side (DS) controller may for portrait format codes and portrait presentations add black or neutral bars to the left and right side screens of the view display. Since most displays are landscape presentation systems, these side bars better frame the portrait image on the landscape presentation screen. Additionally, the DS controller may add picture frame borders about either or both the portrait/landscape artworks.

This portion of the invention relates to a system for re-orienting a user display monitor to a portrait mode, when a digital artwork image to be displayed on the user's display is best shown in a portrait mode, or to a landscape mode, when a digital image to be displayed on the user's display is best shown in a landscape mode. In FIG. 4, the image 218, 220 is electronically marked for portrait or landscape with an orientation code or marker in functional block 222. The artwork is marked, tagged or coded at summation point 219 and the image, as marked, is then transmitted or delivered to the user via telecom system 10. In FIG. 4, the user function 226 generally refers to the artwork selection step 103, 105 in FIG. 1. As shown in FIG. 4, the image, as marked with an orientation marker (that marker being portrait or landscape), is decoded by decoder 230 at the user's location at or near the user's display. The decoder 230 may be embodied in the display-side controller discussed above. The user's view display monitor 250 in FIG. 4 may be a television or other type of monitor or display. Alternatively, as shown in dashed lines in FIG. 4, decoder 229 may be deployed in the distributive streaming server 40 and database 42. In this configuration, the server 40 passes landscape/portrait control commands to the DS controller to enable the DS controller to alter the display on the TV or monitor 12 or 250.

In one embodiment, the user's UPP has data indicating the type of view display monitor, to currently vertical span and horizontal or landscape span of the display screen. In one embodiment, digital image 218, 220 is pre-marked with an orientation code or marker indicating whether the image is a portrait format or the landscape format. In another embodiment, the Sys Op or Blkd Svr detects the vertical span in the horizontal or landscape span of the artwork and embeds orientation code or marker in the artwork digital file. The Sys Op or Blkd Svr may compare orientation code on the artwork with the pre—stored data on the user's display and embedded a further orientation code with the download artwork as noted in step 107, FIG. 1, along with the frame and sequence play data. This is and electronic play alteration of the artwork wherein in the presence of the corresponding portrait-format code and the corresponding landscape-format code, the display-side controller adjusts the user's view display for (i) a portrait view display in the presence of the corresponding portrait-format code or (ii) a landscape view display in the presence of the corresponding landscape-format code.

An another embodiment, user's view display monitor is connected to a mechanical rotation mount which rotates display monitor to either a portrait mode or a landscape mode. In this embodiment, decoder 230, which is part of the display-side controller, obtains or reads the orientation code or code embedded in the image data, and sends the orientation code or orientation command to a mount controller 232. The mount controller 232 is electrically connected to a motor M 240 and the motor rotates the monitor mount on the back (or side) of the user's view display monitor. A 90-degree rotation 249 of the display 250 is sufficient to change the landscape display position to the portrait display position. The rotatable mount enables the user's display to be moved from a portrait position (shown in dashed lines in FIG. 4), in one instance, to a landscape position, in another instance, commensurate with the orientation code earlier embedded in the digital image. The mount controller also has a reset command 233 which moves the user's display monitor to a landscape position which is common for television display units. In this manner, the user's display always shows the image in the correct orientation. In a consolidated system, the user's display is configured by an internet-enabled controller, embodied by Blkd Svr and Blkd DB, which decodes the orientation code from the digital image. The mount controller 232 receives orientation commands 231 as to the correct positioning of the display via short-distance radio frequencies, such as a BLUE TOOTH™ communications sub-system, or infrared control channels. The display-side controller configured to enable the orientation function may utilize BLUE TOOTH™ to transfer the command to the monitor. The orientation command, via the BLUE TOOTH receiver, causes the motor M to rotate the user's display to the correct display position. The reset-to-TV command 233 may be automated by the decoder sensing a “return to cable/satellite station” TV input.

With the mechanical rotational positioner 232, 240 coupled to and controlled by the decoder 230, which is part of the display-side controller, the rotational positioner is mechanically attached to the user's view display. The positioner 232, 240 rotates the view display monitor 250 to either a portrait portrayal (shown dashed lines) or a landscape portrayal (shown solid lines) in the presence of the corresponding portrait-format code and the corresponding landscape-format code. The rotation of the view display monitor may be engaged prior to or during the initial presentation of the discrete visual art piece or discrete AV art piece.

Returning to FIG. 1, once the Blkd Svr obtains the Sel or selected play one for a certain playlist (having temporal framing data and the content sequence data commands) from the customer (process step 105), the server returns in step 107 the particular framing controls for each respective content (e.g., E-CNT 1, E-CNT 2, F-CNT 1) for customer 1 display sequence (1D1), the frame controls for display sequence 2 (1D2), and the frame controls for display sequence 3 (1D3). The frame control instructions are supplied to the display-side controller or local control system (which may have a local processor and memory) for the user's view display monitor. The APP on the user's display may recognize the frame controls and then control the operation of the display monitor.

In step 109, the Blkd Svr downloads or streams content E-CNT 1, content F-CNT 2, and content E-CNT 2 to the customer display monitor. The downloading of the frame controls and sequences can be (a) independent of downloading of the content or (b) integrated with the content. Alternatively, the framing temporal control for the repetition command can be independent of the downloaded content. The content, in one embodiment, may be downloaded once to the display-side controller and replayed as needed per the 1D2 framing controls by the APP on the display monitor (for example, a smart TV having a processor and memory). In other words, the frame controls can be supplied with the content as an integrated signal or the frame controls can be independently stored in the APP which, in turn, controls the display monitor such that when the content is downloaded and replayed on the display monitor, the display is controlled by the respective frame controls locally stored in the display memory (and processed therein) in accordance with the framing controls E-CNT 1 set by the customer. Although step 107 is shown as being separate from step 109, the data flow may be integrated.

In functional step 110, the user changes the frame controls and skips content from server E, that is, E-CNT 2, and instructs a play-the-next-in-line content from the playlist. That user change-of-frame control is sent to Blkd Svr. In functional step 111, the Blkd Svr downloads content F-CNT 1; F-CNT 2; and E-CNT 2 (omitting E-CNT 3).

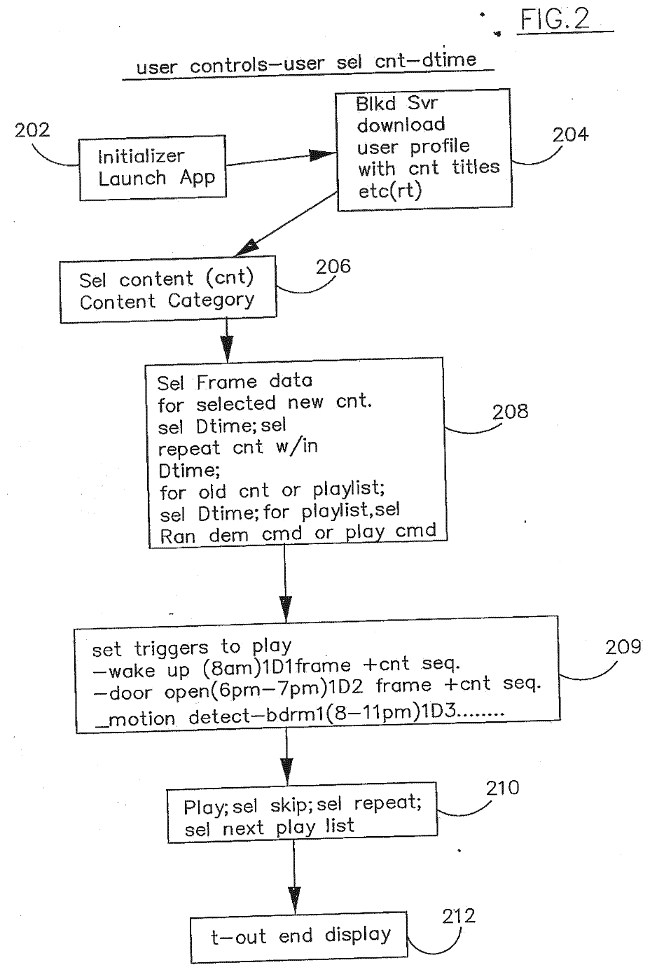

FIG. 2 is a diagrammatic flowchart showing one embodiment of the user controls and user selection of contents as well as content display time (Dtime). It diagrammatically illustrates a user control—user display time flowchart. In step 202, the user initializes and launches the APP in the display-side controller. In step 204, the Blkd Svr downloads previously stored user data from the UPP in order to display pre-selected content titles or playlists, in real time (rt). In step 206, the user selects content or a content category. If the user selects a content category, the user then selects audiovisual clips or static visual images or other items similar to a user building a playlist from musical downstream platforms.

In step 208, the user selects the framing data commands (cmd) for each content. This framing data could include the amount the total amount of time to display the visual art, the repetition of a particular video clip in an overall longer playtime, the orientation of a static video image in either portrait or landscape, and the addition of any musical score that would be played in conjunction with the static visual art. Other framing controls may be presented, such as fade-out/in, brightness, sound volume, etc. Therefore, in step 208, the user selects temporal framing data for selected new content. The user selects display time for that newly selected content. The user selects a repetition count within the display time. For a prestored content or playlist selected by the user and previously stored in the user's UPP, the user selects total display time (D time) and for the playlist, selects the random play command (cmd) or play-standard sequence command.

In step 208, the user, during the display of a particular content sequence, can select a play-on command, a skip command, a repeat content display command, and a command to play the next playlist or content sequence. In step 209, the user can preprogram triggers to play certain framed and content sequences upon certain detected physical events or times in his or her house or office. For example, the user can select that a certain content sequence be displayed when the user opens his or her front door at between 6 PM and 10 PM at night. The APP has a timer which sends Sel cmd 105 to the server as triggered by the open-door sensor data during that time frame. Also, the user can couple motion sensors throughout his or her residence or office to the APP and preprogram the display and play of content based upon movement sensor activation in the room. In a residence, this motion sensor may be in the bedroom of the user. The user can preprogram in his or her UPP and in the APP controlling the display that, upon entering the bedroom at any time between 10 PM and 12 PM, a certain content sequence 1D1 is displayed/played on his or her display monitor in the bedroom and the audio track played (or not) in conjunction with the preprogrammed visual display.

The set trigger function 209 involves the Blkd server accepting a user autoplay command triggered by one of a time-of-day event and a detected ambient environmental condition. The detection of the user entering the bedroom between 10-12 PM is an example of a combination of a time-of-day event and a detected “enter the bedroom” ambient environmental condition. The set trigger function 209 is stored in the UPP (Blkd DB) as a triggered selected play one command and response associated with the time-of-day event and the detected ambient environmental condition. The trigger also needs at least one artwork selection. The display-side controller responds to the time-of-day event and the detected ambient environmental condition and auto-generates and sends the user autoplay command to the streaming controller, Blkd Svr. The streaming controller server, upon receipt of the user autoplay command, downloads to the display-side controller and the view display monitor the temporal play command and the triggered selected play one artwork selection. The triggered selected play one artwork selection is the artwork selected for the 10-12 PM “enter the bedroom” event.

In FIG. 2, step 209, examples are provided for timed sequence displays. At 8 AM, play content 1D1 frame and content sequence. When the door opens between 6 PM and 7 PM on a particular day (M-F), the system is preprogrammed to display 1D2 framing data and the related content sequence. Upon detection of motion in a bedroom between 8 PM and 11 PM, the system is programmed play display sequence 1D3. In process step 212, the system has a timeout on the display for each sensory triggered event.

As programmed by the user or customer, various video art displays can be viewed and controlled. For example, the user may select video art clip VA 1 and limit the play time for VA 1 to an eight second (8 sec.) timeframe; may reloop or repeat that eight second VA 1 play for X number of repeat segments; then select another video art clip VA 2, rotate the image for VA 2 to landscape on the user's view display monitor, and select a playtime and a “repeat entire display sequence” for total D Time.

In conjunction with FIGS. 5 and 6, the artwork datastore may be in an NFT or non-fungible token artwork datastore. The NFT artwork datastore may be an on-chain NFT artwork piece or a series of artworks stored in one or more blocks of the NFT or the artwork may be stored in an off-chain NFT datastore, such as in the IPFS. The Interplanetary File System (IPFS) is a distributed file storage protocol that allows computers all over the globe to store and serve files as part of a giant peer-to-peer network. In this embodiment, the Sys Op server or Blkd Svr accesses the NFT artwork datastore via an NFT artwork access control stored in the NFT artwork token wherein the NFT artwork token is a unique NFT artwork token of a plurality of NFT artwork tokens in the NFT blockchain and wherein the plurality of NFT artwork tokens are maintained on the linked NFT blockchain. The Sys Op server or Blkd Svr accepts the selected play one (steps 103, 105 in FIG. 1) when the user's id associated with the display-side controller is also associated with the unique NFT artwork token because the user is only entitled to view the NFT locked artwork if the user's UPP id either has a match or is associated with the user's id in the NFT token. It is known that, to obtain the benefit of an NFT, the owner must have ownership over the NFT token. In other words, the NFT owner must match or be associated with the owner's UPP data in the inventive system and method. To this effect, user's id in the UPP facilitates obtainment of the artwork selection from the NFT artwork datastore.

Key elements of the NFT system and process are diagrammatically illustrated in FIGS. 5-12 and include: obtaining artworks from Content Creators, implementing Digital Rights Management (DRM) for the artwork using blockchain NFT structures; employing a Smart Contract (SM) based art content licensing (time based, financial based, etc.); configuring the Smart Contract as a distributed royalty management system (many owners of one VA or AV asset); generating artwork protocols to enable Content Creators to auto-upload artwork (artwork, music, AV Works) into pre-formatted NFT structures; providing hardware and software solutions to Content Creators; using Multi-APP models (Twitter, Instagram (IG), Spotify) as promotional tools to advertise the NFT-based artwork; making payments of royalties made using blockchain or distributed ledger technology (DLT); and employing time-based access for all artwork on the NFT artwork datastores.

In this manner, inclusion of a smart contract (SM) in one SM block of the linked NFT blockchain permits the SM contract to include and apply DRM display controls in accordance with the encoded DRM applied by the Sys Op Svr and the Sys Op DB (Blkd Svr and Blkd DB) during downloading of the artwork selection to the user's display-side controller. The encoded DRM applies a DRM download action from a group of DRM download actions including a time-limited teaser play of a portion of the artwork selection, a single play of the artwork selection, and a one play of n plays of the artwork selection. The encoded DRM associated with the selected play one and associated artwork selection is stored in the UPP of the consumer or customer. Further, either the display-side controller or the streaming controller applies the DRM download action to the artwork selection thereby altering presentation of the artwork selection on the consumer's view display.

These elements engage NFT creative content controls using the divisible nature of copyrights owned by Content Creators. These include: reproducing or copying the copyrighted work. The NFT Token Owner's right to display artwork on his/her own screen. The term “display” includes the right to display/play artwork, music or any AV content. The creative content controls enable: personal fractionalized use by the NFT token owner; and distribution of copies by sale, transfer, rental, or lease. The NFT Token Owner rights are different from and are not included in Commercial Rights (“Comm Rights”). The system and method may also permit fractional use for public performance or public display (artwork, literary, music, AV) as compared to the private use by the user or customer. The system also incorporates the rights to publicly and/or privately perform or transmit sound recordings via digital transmission. The creative content controls enable preparation or creation of derivative works based on original artwork. Typically, the Content Creator reserves his or her right to original content format but the Content Creator may license or transfer (assign) his or her derivative work rights as part of transaction to monetize exclusive Comm Rights. These Comm Rights may be limited by fractionalized use, or time-based limited, or industry/market limited Comm Rights.

FIG. 5 diagrammatically shows the streaming process and control process by and end user. FIG. 6 diagrammatically illustrates nonfungible token (NFT) accessible artwork (off-chain art on IPFS). FIG. 6 diagrammatically illustrates the current concept that nonfungible tokens, which are blockchain data structures, are maintained on Web3, in contrast to FIG. 5 which shows Web 2 as distribution system discussed above in connection with FIG. 1. In FIG. 6, nonfungible token ownership is shown by NFT minting function 310 which utilizes a tokenization function 312 which in turn generates NFT ownership tokens N1 and N2. In Web 3, artwork is stored in the IPFS storage as AV1, AV2, Art1, etc. The term in FIG. 6 “AV” refers to audiovisual works in the term “Art” refers to static visual artwork.

FIG. 5 shows a Web 2 data structure. The end-user selection 314 as diagrammatically illustrated in FIG. 5, requires activation of a is activation of a monetization facility 316 which may be Itunes® payment, Google® payment, Stripe™ payment or credit card (CrCd) payment. As explained above, artwork may be stored in a cloud-based datastore 318. The Sys Op server, upon request of the user or customer, delivers or screens the artwork first by transcoding the artwork in function 320 and, in some situations, applies digital rights management DRM in function 322 prior to engaging streaming system 324 the user's view display monitor. Some DRM includes commercially available Widevine™ DRM and FariPlay™ DRM systems.

It is known that transcoding is a key task in an adaptive streaming workflow for video. It converts an encoded digital file or set of files into an altered set of digital files that better meet the needs of hardware or the audience. It is particularly important for ensuring content can be viewed on the widest possible range of devices. The DASH or Digital Adaptive Streaming over HTTP (DASH) program allows streaming videos to be played over a variety of different internet connections. This format divides a video file in to smaller components before it is set to play through a streaming telecom network. Each of the divided-out components can be integrated into a stream as it is playing without viewer disruption. DASH streaming is valuable to users on slower telecom networks. The DASH program changes the bit rate delivery for these streams. With DASH, users with a slower internet connection get video at a higher speed rate. HLS is HTTP Live Streaming (HLS) with adaptive bitrate outputs. HLS is a delivery mechanism for streaming audio and video (AV) content over the internet developed by Apple®. HLS supported format that supports the HTML5 video tag, as well as a host of other web players and physical devices. One of the main benefits to HLS is that it utilizes Adaptive Bitrate streaming (ABR). With ABR, the video is encoded into a “ladder” of resolutions and bitrates commonly referred to as “renditions”, “rungs”, or “layers”. The delivery system (a player) dynamically selects the optimal bitrate to be delivered to the end-user viewer based on the viewer's current network conditions. If the viewer's available bandwidth drops, the player seamlessly switches to a lower-bitrate video layer to prevent video stalling and buffering.

The inventive system, method and data structure envisions certain consumer-based products for Content Creator's work posted and locked in an NFT. NFT Consumer Token Owner (a “Cnft” Token) enables the token owner the right to reproduce and privately display artwork (artwork, music, AV work) on any personal display screen/player (agnostic to hardware). The Cnft Token Owner has the right to sell, transfer, possibly rent or possibly lease or lend the artwork via access to the NFT link to the artwork locked into the NFT. A Smart Contract (SM) controls both access to artwork and use of artwork by Cnft. Cnft Owner has a right to sell and transfer Cnft Token. After the token sale, the Cnft Token is destroyed/burned and the new Cnft Owner data is locked in a newly minted NFT block in the blockchain as a replacement Cnft Token. Cnft Owner's right to rent, and lease, is limited to private, non-public display and/or performance. Any rent or lease may be limited in time (a temporal control) and further may be limited via the smart contract locked into one of the blocks in the NFT blockchain. The Cnft Token Quantity is typically limited, e.g., 100 tokens (1% fractionalization of use). The NFT smart contract SM distributes royalties to NFT Platform Owner, which is typically the Sys Op who operates Blkd Svr and Blkd DB, and royalties to the Content Creator. The NFT artwork contains digital rights management (DRM) code embedded/monitored by smart contract. Each Cnft Token contains DRM coding. Smart Contract gathers NFT-DRM use data and access data and in some occasions statistical use data and display/play device data (for example, the user's device router data). For groups or collections of content (artwork, AV material, and/or audio digital data, sometimes referred to herein as Content Group NFT), access to these multiple artworks and audio works are locked into multiple NFTs. The Content Group NFT has pointers/links to the “grouped” Single Work NFTs. Consumer subscriptions are available for the Content Group (“Cnft-GRP”). Cnft-GRP Subscription NFT sales or licenses similar to a single artwork NFT but (a) may be time-based or temporal limited; (b) may be limited by number of plays or downloads # of display/plays limited (a Quantity (“Q #”) limited); and (c) limited by royalty flows from the use or display of the Cnft-GRP by the Cnft token owner, and (d) further limited to defined sub-licensed parties, theses parties defined in the Smart Contract.

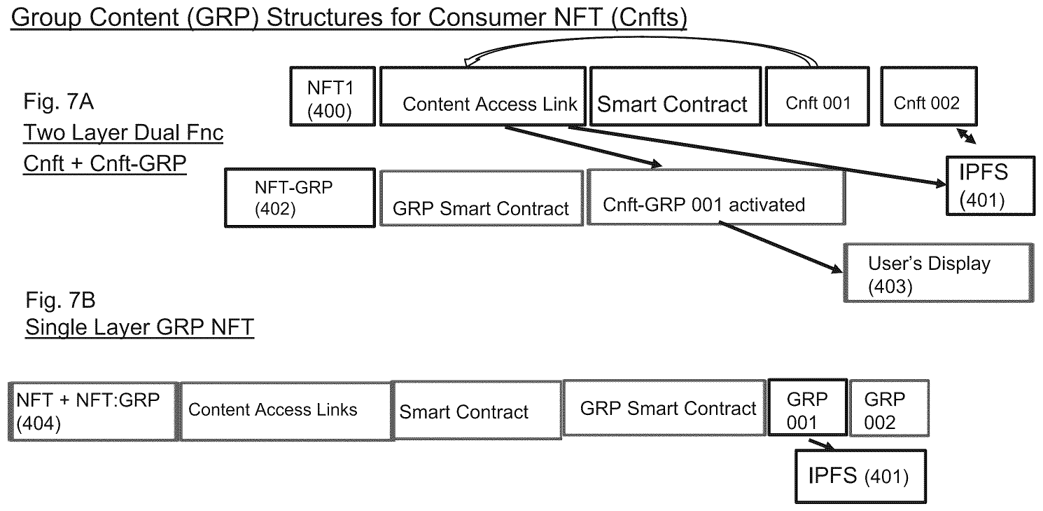

FIGS. 7A and 7B diagrammatically illustrate two data structures which made the employed for group content (GRP) structures available to the consumer, customer or user who owns the customer NFT token identified as the Cnft owner-token or the GRP owner-token. FIG. 7A shows for NFT 1 (blockchain 400), in connection with nonfungible owner token Cnft 002, access to an off-chain artwork datastore IPFS retaining the artwork and, in connection with NFT token Cnft001, access to a 2^{nd} NFT blockchain 402 which holds a group of art pieces Cnft-GRP 001 which art pieces are ultimately downloaded to the user's viewable display 403. In blockchain 402, the customer's access may be limited by the GRP smart contract. In NFT1 blockchain 400, access may also be limited by the smart contract for both token owners Cnft001 and Cnft002. If the smart contract in blockchain 400 approves the customer associated with NFT customer-token Cnft001, then access may be secondarily approved by the smart contract GRP contract in blockchain 402. For example, the GRP smart contract in blockchain 402 may (a) require additional payment or (b) may impose a time-limited access or Q #limited access to the artwork collection represented by GRP 001. The artwork in GRP001 most likely would be located in the IPFS. Once both SM contracts approve access by the token owner Cnt001, then the group artwork is downloaded to the token owner customer as discussed above. It is known that NFT's typically provide an access point to off-chain stored artwork. FIG. 7a shows a two layer group content GRP data structure.

FIG. 7B diagrammatically shows that the NFT blockchain 404, also identified as NFT+NFT: GRP, holds a point or an access link to a collection or group of art pieces in owner-token GRP 001, permitting access to multiple art pieces in an off-chain datastore IPFS 401. The single layer blockchain 404 also includes content access links that permit access to the GRP sequential artwork in the IPFS. In single later GRP NFT 404 contemplates that different token owners may have different access rights. For example, the smart contract in blockchain 404 may permit access to a single artwork in contrast to GRP smart contract which permits access to a group or collection or sequential artwork playlist. In other words, there may be Cnft token owners in blockchain 404 which are different than the GRP token owners. In connection with all NFT blockchains, the smart contract in the blockchain can check the user's id in the Blkd DB UPP prior to passing the access control to the Blkd Svr and thereby permitting the Blkd Svr to obtain the artwork selection from the NFT datastore (whether on-chain, or off-chain) and further facilitating the download of that NFT-based artwork to the user or customer.

The following discussion compares consumer NFT-based artwork products and services with commercial products and services. For all artworks (artwork, music, AV), the Sys Op may retain and reserve Commercial Enterprise Rights (“Erights”) which should be (a) documented by a contract with the Content Creator (typically, an off-line contract but potentially in an automated system, a smart contract in an NFT blockchain); and (b) the scope of Erights reserved by the Sys Op is documented and described to prospective Cnft token owners in a publicly viewable cell in the NFT blockchain. The Master Enterprise NFT (“ME-nft”) in the NFT blockchain describes the scope of the Erights and the operation of the Commercial Smart Contract (“CommSM”). Erights permit the Sys Op (or its assignee/designated party) to create derivative artwork based upon the Content Creator artwork. This is embedded and explained in the Content Creator contract with the Sys Op. In the first instance, the Content Creator gives Erights to Sys Opp (the off-line contract). In the second instance, the Sys Op should be transparent to Cnft Token Owners as to how their rights may be diluted or otherwise effected by reserved Erights. The value of an NFT Work (the NFT delivery system for the artwork, music, AV work) is generally based upon the concepts of scarcity, quality of artwork, 3rd party commentary and advertorials (ads promoting the artwork). Erights and scarcity valuations are based upon “view/display/play” quantities, and the rate of change of the “view/display/play” quantities. Time based scarcity relates to the “play time of music” or number of seconds the artwork can be shown in the derivative Commercial Artwork (under license by Sys OP). The overall quantity-based (Q #) of the owner token minted by the Sys Op is a natural measure of scarcity. Other factors defining scarcity include: (i) how many commercial Erights per year is the Sys Op permitted to license; (ii) market differentiation for a particular Eright (sports, entertainment, health and beauty aids, etc.); (iii) “black-out periods” for certain Erights, for example, once artwork is used in a commercial advertising a single product, the artwork cannot be used for another 2-3 years (Eright exploitation limited to Q #); (iv) scarcity rule trigger(s), for example, if the artwork is sold Q #(e.g., once 1,000 Cnfts are sold, then Erights available); (v) other scarcity rule triggers, for example, a lapsed time-based (e.g., after 1 year from initial NFT drop, Sys Op can exploit Commercial Erights); (vi) another scarcity rule trigger may be based upon the $ value of Cnft (e.g., if Cnft sales exceeds $5,000, then Sys Op can exploit Erights, or contrariwise, if in 1 year, Cnft sales do not exceed $5,000, then Sys Op can exploit Erights); and (vii) market/industry differentiation (e.g., no limit on movie/theatrical Erights; after or post 1 year of the NFT drop or first mint event, then commercial advertising Erights permitted, etc.). The Sys Op, in designing the smart contracts, can combine one or more of these automatic controls to effectively improve the use of the artwork, the distribution of the artwork and the renumeration to the Content Creator, the NFT token owners and the Sys Op.

It is important that a disclosure be made of Erights to the consumer or NFT token owner relative to the scope, duration and extent of the Commercial Products supported by the Sys Op. First, the “value” of an NFT artwork (artwork, music, AV work) is generally based upon concepts of scarcity, quality of the artwork, 3rd party commentary and advertorials (ads promoting the artwork). Second, Content Creator and all other Cnft NFT Token Owners have the right to view the master enterprise ME-nft and understand the scope of potential Commercial Erights that may be commercially exploited. The ME-nft describes the Erights that the Sys Op can exploit the artwork. A Commercial Smart Contract (“Comm SM”) built into the NFT controls the distribution of royalties and payments for Erights. Third, as an example, some potential token purchasers of the Cnft would like to know if the artwork/music will be used in an advertising commercial, and to what extent. For example, the Erights on music could be limited to no more than 5 second clips of the music. Artwork Erights could be limited to no more than a 2 minute display in a movie.

The following is a list of consumer and commercial products which can be supported by the innovative data structure. (a) NFT Token Owner (ability to resell token) vs. positive and negative effect commercial rights; (b) NFT Token Collector permits the display and token resale; (c) NFT (ability to play artwork or AV with portability); (d) Sys Op may be permitted to fractionalize the Erights and sell selected Erights to Commercial NFT Owners (these are Enterprise Tokens (“Enft”) who wish to make derivative works of the artwork locked in the NFT blockchain; (e) Commercial rights include: publishing rights (permitting re-publishing of the artwork or AV); (f) NFT may cap or limit Cnft minting or fractionalization to enhance scarcity (emulating the physical art market); (g) the Sys Op providing an open Artwork network wherein the Sys Op could reserve Erights for Commercial Use and permit Content Creator to give-away the artwork/music/AV in pre-formatted NFT blockchains, having SM contracts providing a stream of royalties to the Content Creator; (h) limiting commercial licensing (time based (24 days, 30 months, lifetime); (i) Sys Op can develop a subscription-based NFT artwork platform; and (j) the Sys Op can have Master Enterprise NFTs (“ME-nft”) wherein the ME-nft blockchain describes the scope of the Commercial Erights and the operation of the Commercial Smart Contract (“Comm SM”) and Comm SM monitors the use of artwork by the Commercial Licensee, makes automatic royalty payments and reports of use or artwork by Comm Licensee.

Time-based scarcity is important for both consumer in commercial NFT artwork products and services. For all NFT-based artwork, music, AV, Sys Op may obtain and reserve Commercial “Enterprise” Rights (“Erights”) which are documented in the Master Enterprise NFT (“MEnft”). The MEnft is locked in the NFT Blockchain. Erights permit Sys Op to create derivative works based upon the Content Creator artwork. Time-based scarcity involves competing characteristics: (i) NFT token owner ability to resell, as a collector; (ii) the collector may display or resell the NFT token; (iii) for the Commercial product or service, publishing rights are important; (iv) the artwork accessed by the NFT must have the ability to play the art with portability; (v) by limited NFT tokenization, this emulates the physical art market; (vi) an open Sys Op NFT platform increases value of all artwork on the platform; (vii) master licensing of Erights can be time based in hours, days, months or years; (viii) a subscription model supports continuing revenue to the Content Creator and the Sys Op.

Characteristics of grouped artworks, that is, a playlist of artwork include: (a) a collector of multiple Cnfts can play his/her own collection via the inventive system; (b) the Sys Op can provide a Collector-unique or personalized artwork group or playlist Cnft-GRP, referred to above as the Cnft-GRP001; (c) under prescribed circumstances, the Collector and owner of Cnft-GRP001 may fractionalize the use of Cnft-GRP001. The minted NFTS may be labeled or coded as Cnft-GRP001.001, Cnft-GRP001.002, Cnft-GRP001.003 etc. and may be permit only time-limited play/display; (d) the Collectors could be DJs, online celebrities, etc. which promote the Sys Op collection; and (e) buyers can purchase minted NFTs (Cnft-GRP001.001, etc) and trade the same as long as the time period in the SM contract for that fractionalized NFT has not expired.

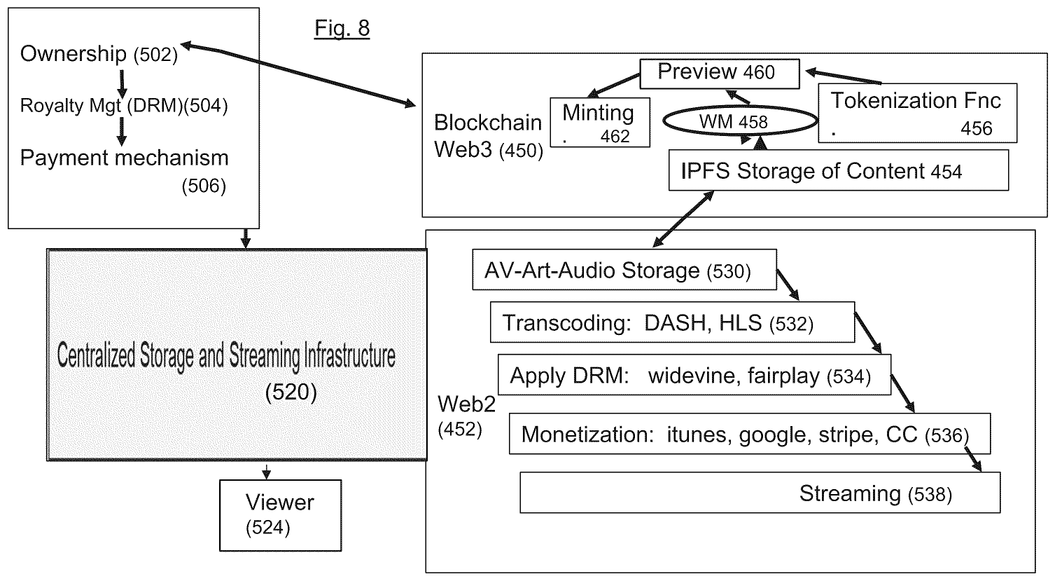

FIG. 8 diagrammatically illustrates integration of an NFT having access to art pieces, the tokenization for those art pieces, ownership characteristics, royalty management systems through a digital rights manager or management (DRM), and the various software tools and processes for the streaming artwork. As described earlier, the NFT-based blockchain is generally viewed as being Web 3 or platform 450. The artwork is stored in IPFS 454. In her to carry out tokenization function 456, prospective NFT purchaser typically reviews some variation of the artwork. One data structure to avoid wholesale copying of the artwork involves the use of watermarking the artwork as shown in function 458 prior to previewing function 462 reveal artwork subject to the NFT prior to purchase of NFT token by the prospective purchaser. Upon purchase, the Sys Op mints a new ownership token in function 462. Once this ownership function 502 established, royalty management in the form of digital rights management DRM function 504 is applied to the artwork in IPF S's datastore 454. Also, a payment mechanism function 506 is established for the NFT exploitation of the artwork.

The centralized storage in streaming infrastructure 520 is generally discussed earlier but effectively includes utilization of Web 2 platform 452. This includes artwork storage function 530, transcoding function 532, application of DRM function 534 and monitored as a function 536. Finally, streaming function 538 supplies and distributes the artwork to view display monitor 524.

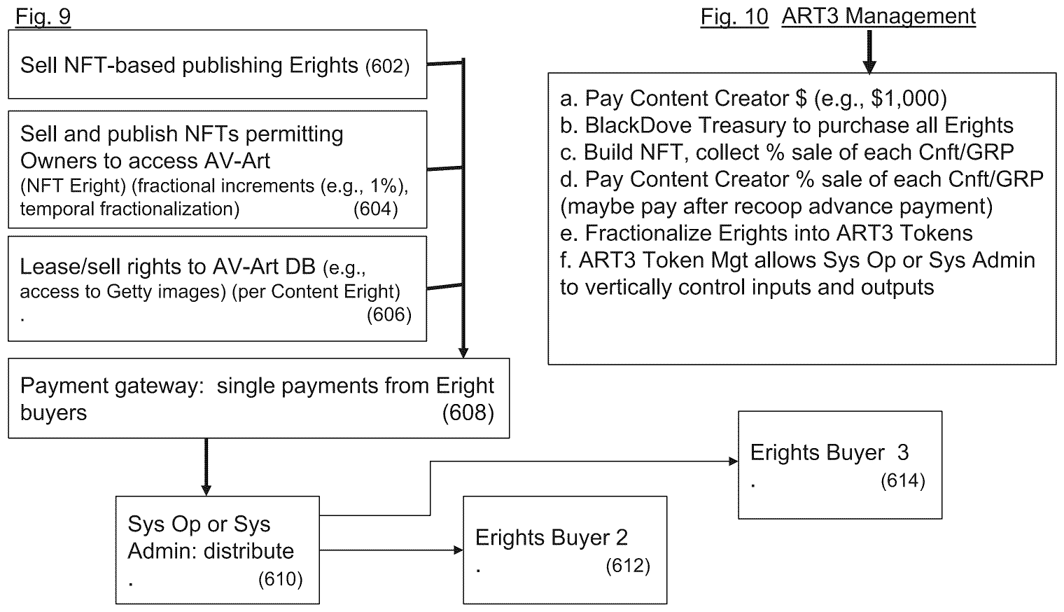

FIG. 9 diagrammatically illustrates distribution and markets segmentation for the user controllable AV-artwork steaming data structure with conjunctive configurable NFTs wherein NFT blockchain systems can be used to publish in distribute artwork. The global sale of NFT publishing commercial Erights is accomplished in function 602. After selling the global publishing Erights, the system and data structure established to sell and publish consumer NFTs (Cnfts) which permits those consumers to have access to artwork and AV art in fractionalized increments in which further may be limited by temporal or time-based fractionalization in function 604 the lease or sale function 606 extends to a global artwork database or AV database similar in nature to the Getty™ arts platform. Leasing and sales rights to the databases may be coincidental and limited by underlying commercial or content Eright. A payment Gateway function 608 enable single payments by Eright buyers. The result being that the Sys Op or Sys Admin activates a distribution function 610 issuing NFT tokens to Eright buyers 2 and 3 in function blocks 612, 614.

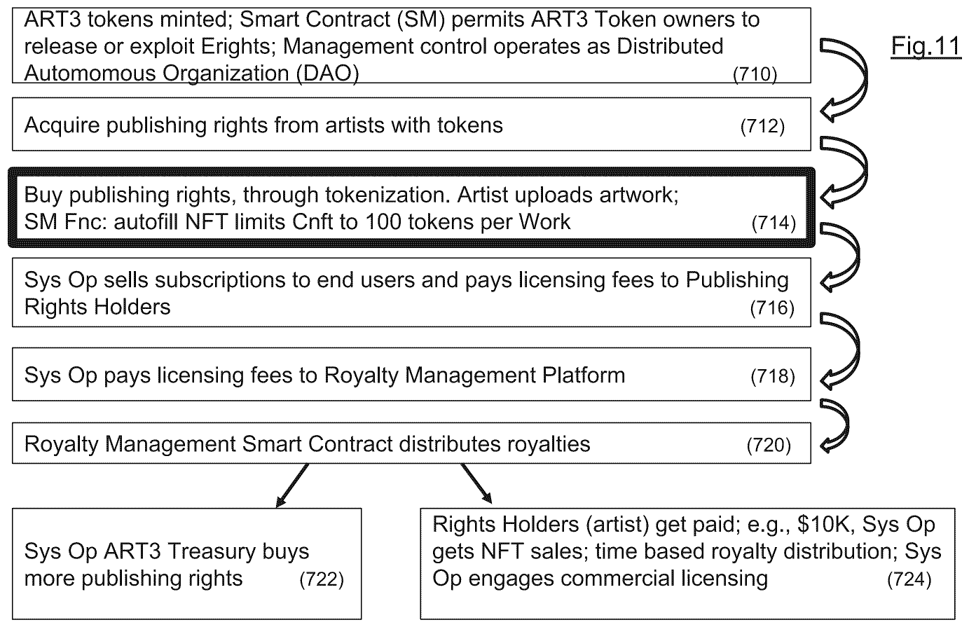

FIG. 10 diagrammatically shows further conjunctive configurable NFTs including token coin generation. Art3 Management Process 700 includes: (a) an initial payment to the Content Creator $ (e.g., $1,000) upon the Creator uploading artwork to the preformatted NFT blockchain (typically stored off-chain in the IPFS; (b) the Sys Op issuing “treasury NFT tokens” to the Creator to purchase all commercial Erights from the Creator; (c) building out the consumer-based NFT blockchain, collecting a percentage of the sale of each Cnft/GRP token; (d) paying the Content Creator a percentage of each sale of each Cnft/GRP (maybe pay after the Sys Op recoops the advance payment to the Creator); (e) the Sys Op building a further NFT to fractionalize the commercial Erights and sell or mint ART3 Tokens; and (f) The Sys Op ART3 token management allows Sys Op or Sys Admin to vertically control inputs and outputs on multiple levels.

FIG. 11 diagrammatically illustrates one method, process and data structure having an organizational structure involving a distributed autonomous organization (DAO) to control the conjunctive configurable art NFTs including token coin generation, royalty payments through smart contracts on the blockchain. In function block 710, ART3 tokens are minted by the Sys Op. The Smart Contract (SM) permits ART3 Token owners to release or exploit commercial Erights (possibly for a limited period of time, thereby providing a time-based inventive to the token owners). The management is a Distributed Autonomous Organization (DAO) and management control operates is distributed to all DAO owners. In function block 712, the Sys Op acquires publishing rights from artists and Content Creators with tokens. In function block 714, the Sys Op buys publishing rights with tokenization. The artist uploads artwork and the SM contract functions to (a) autofill the art into the artwork storage, auto-build the SM contract limiting consumer NFTs to a limit count of 100 Cnft tokens per artwork. In function block 716, the Sys Op sells subscriptions to end users for playlist collections of artworks, and pays licensing fees to Publishing Rights Holders, such as commercial Erights holders (who are also represented by NFT tokens. In function block 718, the Sys Op pays licensing fees to the Royalty Management Platform. The royalty management platform is represented by the SM contracts in the various NFTs for artwork. In function block 720, the Royalty Management Smart Contracts distribute royalties. As a result, in function 722, the Sys Op ART3 Treasury tokens are used to buy more publishing rights. Also, in function block 724, the Rights Holders (artist) get paid by the Royalty Management Platform as part of a time-based or sales-based royalty distribution. The Sys Op continues to engage commercial licensing of the Erights.

One example of a DAO using DRM may include permitting a potential DAO member (these members having voting rights in the DAO, each DAO token, membership indicia or DLT cell having one vote), to view watermarked artwork prior to buying into or giving value to the DAO. Another example of a DAO using DRM is to permit NFT token owner to time-fractionalize their NFT artwork access to others for a pre-set period of time to enhance the value of the artwork and the DAO in general. Further, prior to granting Commercial Erights, the DAO may be activated to vote and approve/disapprove of the grant of Erights. The DAO ownership tokens expand the efficiency of the artwork display and distribution system by enabling the DAO to make major system-wide decisions quickly and easily. Although SM contracts in NFTs can regulate access, distribution, NFT token minting, and local DRM controls, once locked in the NFT, the SM contracts are generally not changeable. The application of a DAO as a master controlling organization, improves the efficiently of the entire system, to account for events either not anticipated or dealt with in the SM NFT contracts. For example, one art piece may become highly popular and the DAO could be used to limit or stop new NFT token generation, assuming the artwork is NFT-based. Alternatively, upon approval of the DAO members, for poor selling artwork, the DAO could organizationally approve additional release of more NFT tokens than originally planned.

An improved, more efficient data structure uses the DAO in the following manner. Although the smart SM contract in the underlying NFT can operate in a simple manner, limiting NFT token generation and controlling the transfer of tokens from one owner to another, the SM contract in the NFT is a simple operational program. It cannot handle nor contend with all variables that the distribution of the NFT-based artwork may encounter. For example, the NFT-based artwork may, upon death of the artist, become much more valuable compared to when the artist was alive. The DAO overseeing the NFT-based art, with an organization SM contract, can monitor pricing of NFT token sales or number of views by prospective NFT buyers and issue a call for a vote to alter the SM contract in the subject NFT. Other events not contemplated by the SM contract in the NFT include a sudden popularity of the artist, justifying recall of or limitation on new NFT token sales. Other acts of God or unforeseen or unpredictable events can be addressed in the DAO overlay atop the NFT artwork datastores. Hence, efficiency improves with unpredictable event resolution with the use of the organizational SM contract configured in the DAO platform.

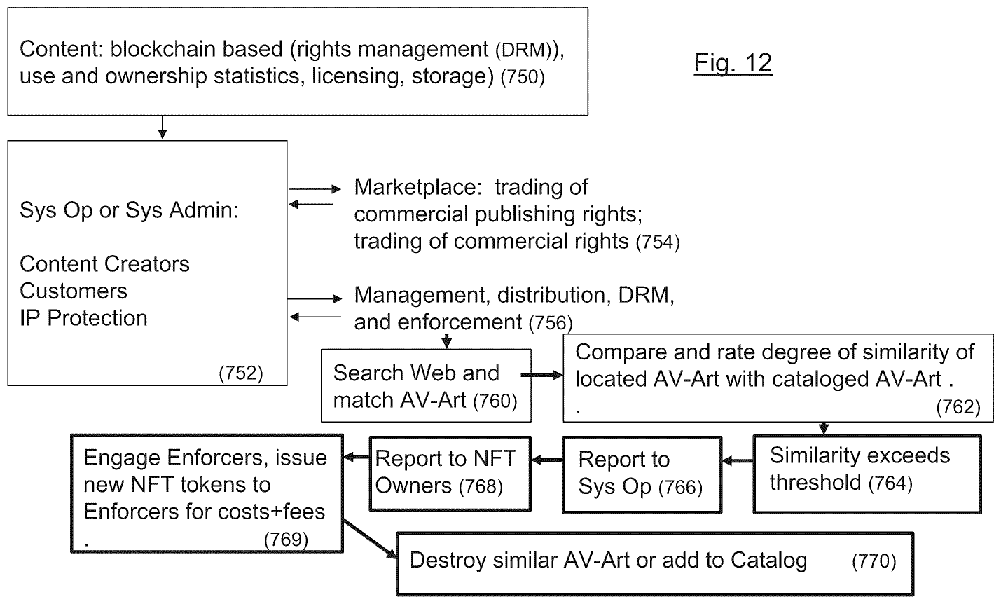

FIG. 12 diagrammatically illustrates a high-level structure for the conjunctive configurable art NFTs including trading marketplaces and enforcement processes. Content function block 750 recognizes that the artwork is NFT-based and promoted in addition to applying digital rights management DRM for the use of the artwork additionally, ownership statistics, use statistics, licensing statistics and data storage is monitored in function 750. Block 752 recognizes that the Sys Op or Sys Admin has a significant role to play in commercializing the artwork as well as gathering and obtaining artwork from content creators and providing distribution system and data structure for customers of artwork as well as the commercial Erights further, intellectual property protection entities are engaged in this system. The marketplace function 754 includes treating commercial publishing rights in treating other commercial rights. The management function 756 involves distribution of the artwork, management and control of the DRM and enforcement of intellectual property surrounding the artwork. In connection with enforcement, function 760 involves conducting the search through the Internet in weds to match the collected artwork subject to the NFT-based data structure and comparing that collected artwork with otherwise public artwork.

Function 762 compares the public artwork with the collected artwork (that is, the artwork subject to and collected and distributed by the NFT-based data structure) and assigns a degree the or rates the degree of similarity of the collected artwork, which is called the catalog artwork with public collected artwork. Function 764 makes a determination whether the similarity exceeds a predetermined threshold. Function 764 may be automated by image matching software and artificial intelligence AI software and image matching tools. Function 766 reports resolves of the potential intellectual property violation to the Sys Op. Function 768 reports the results consumer NFT token owners or the commercial Eright token owners in accordance with the disclosures and contracts made with those consumers and commercial token owners. Function 769 engages intellectual property enforcers and recognizes that and additional layer of NFT tokens may be generated to support enforcement of the against the non-authorized publication of the subject artwork. These enforcement tokens would cover costs and fees of the enforcement entities. Step 770, infringing public artwork is either destroyed or arrangements are made to include that infringing artwork into the NFT artwork catalog.

The foregoing data structure includes transcoding the artwork selected by the NFT token owner during the download of the artwork and audio selection to the NFT token owner's display-side controller and ultimately to the token owner's monitor and acoustic player. The smart contract (SM) in a SM block of the linked NFT blockchain has therein DRM display controls. These DRM display controls including at least a play-code and a no-play-code. Further, a distributed autonomous organization (DAO) blockchain is provided for management of the NFT-based artwork distribution system. The DAO has a smart DAO contract (SDAO) in a linked DAO cell formed the DAO blockchain. DAO owners have DAO tokens permitting them to vote on management decisions. The SDAO generates an approved access code to the SM upon an execution output from the SDAO, and the SM generates the play-code upon receipt of the approved access code.

In the drawings, reference is made to certain abbreviations. The following Abbreviations Table provides a correspondence between the abbreviations and the item or feature.

Abbreviations Table

| | |
|---|---|
| Admin | Administrator of the System |
| APP | software program running on the computer-based device, |
| | cell phone, STB, tablet, including a thin client program on |
| | the user's devices, in communication with the server |
| ASP | application service provider - server on a network, such as |
| | the Blkd Server |
| AV | audio visual |
| cmd | command |
| cntl | control or controller |
| Cnt | content, typically, creative content such as artwork |
| comm. | communications, typically telecommunications |
| comp | computer having internet enabled communications module |
| CPU | central processing unit |
| CrCd | credit card, and card no., expiry date, security code, etc. |
| DAO | distributed autonomous organization |
| DB | data base |
| DRM | digital rights management coding |
| disp | display, typically a monitor or display screen |
| displ | display, see above |
| doc | document |
| e.g. | for example |
| F or f | frequency is the repeat cmd for a visual art |
| fnc | function, typically a computer function |
| I/O | input/output |
| id | identify or identification |
| IP addr. | internet protocol address of internet enabled device |
| mem | memory |
| mic | microphone or audio pickup device |
| NFT | nonfungible token with a blockchain data structure |
| ntwk | network, a telecom network, typically internet |
| opt | optional or alternative program or module |
| pgm | program |
| ph | phone, namely an internet enabled phone, such as a smart |
| | phone |
| PII | personal identifying data, typically a customer name, |
| | address, phone number, SSN, CrCd or other data |
| pmt | payment, sometimes a payment processor for CrCd |
| | transactions |
| proc | processor, typically a microprocessor |
| Pty | party engaged in telecomm or internet enabled |
| | communications |
| P/W | password |
| rcd | database record or record profile |
| re | regarding or relating to |
| RQT | request |
| rev | review |
| Rpt | Report |
| rt | real time, may include day and time stamp data |
| sch | search |
| SDAO | smart contract operative to execute management decisions |
| | in a distributed autonomous organization (DAO) |
| sel | select |
| sess | session, as in telecomm session during a play or download |
| | on an entire playlist |
| sig cond | signal conditioner |
| smart ph | smart phone coupled to the internet |
| sms | text message |
| SM | smart contract |
| spkr | speaker or audio announcement device |
| std | standard, typically protocol set by a group and accepted by |
| | the system operator |
| stmt | statement, as in bank statement, or payment made statement |
| Svr | sever, as in web server |
| sys | system |
| Sys Admin | System Administrator |
| Sys Op | System Operator |
| t | time |
| t-out | the expiration of a time-out clock |
| tbl | tablet computer |
| telecom | telecommunications system or network |
| txr | transmitter - receiver device, maybe BLUETOOTH (tm), |
| | lan, wireless telecom network, or radio frequency |
| UPP | user's personal profile, to be complete prior to inputting |
| | content selection |
| URL | Uniform Resource Locator or other network locator |
| w/ | with |
| w/in | within |
| w/out | without |
| w/r/t | with respect to |

### Description of Typical System Features

The system described above notes that the user has at least one, and sometimes multiple Internet-enabled (IE) devices, such as, smart phone, cell phone with an APP, tablet computer, computer, or other IE device that is internet enabled. It is currently contemplated that the display-side controller communicates with the steaming controller via the internet using the router. For the display of artwork, the display-side controller can be configured using various pieces of computer-based hardware devices and the communications coupling to the TV or monitor can be made in various manners known to persons of ordinary skill in the art. Computer tablets and other electronic devices may have an APP that, when activate, transforms that device into the display-side controller. The APP is an internet portal that permits the person to access the Blkd server and the Blkd database, and, by default, a wide variety of artwork datastores and systems. If the user communicates with the system in a voice mode, the user interacts primarily with an interactive voice response system or module, an IVR. The display-side controller may use such voice controls. The Blkd server and database may be configures to translate the oral commands and selections into commands and intelligent data streams to accomplish the functions discussed above. The present invention relates processes data via the described computer-based systems, over the Internet and/or on a computer-supported network (LAN or WAN), with computer programs, computer modules and information processing systems to accomplish the selection, display and controllable aspects of the inventions described above.

It is important to know that the embodiments illustrated herein and described herein below are only examples of the many advantageous uses of the innovative teachings set forth herein. In general, statements made in the specification of the present applications do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art. For example, the Blkd server and DB may be completely cloud-based.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits. Furthermore, the computer readable medium may include computer readable information in a transitory state medium such as a network link and/or a network interface, including a wired network or a wireless network, that allow a computer to read such computer readable information.

Those of skill in the art will appreciate that the various illustrative modules, components, and method steps described in connection with the above-described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, components, engines, and method steps described in connection with the embodiments disclosed herein can be implemented or performed with hardware such as a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor is hardware and can be a microprocessor, but in the alternative, the processor can be any hardware processor or controller, microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm and the functionality of a component, engine, or module described in connection with the embodiments disclosed herein can be embodied directly in hardware, in software executed by a processor, or in a combination of the two. Software can reside in computer or controller accessible computer-readable storage media including RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention.

The claims appended hereto are meant to cover modifications and changes within the scope and spirit of the present invention. What is claimed is:

1. A method for distributive streaming artwork with selection and temporal user controls comprising:
providing an artwork datastore storing digital versions of artwork, wherein the artwork is one or more of a plurality of discrete visual art pieces and a plurality of discrete audio/visual (AV) art pieces, the artwork datastore including one or more an artwork database, an artwork cloud datastore, an on-chain non-fungible token (NFT) datastore, and an off-chain NFT datastore;
providing a user view display for the artwork;
providing a display-side controller operative to control the view display;
providing a distributive streaming controller communicatively coupled to the display-side controller, the streaming controller accessing artwork from the artwork datastore;
accepting, via the display-side controller, a user artwork selection for a selected play one visual art piece or AV art piece respectively from the plurality of discrete visual art pieces and the plurality of discrete AV art pieces;
accepting, via the display-side controller, a temporal play command in connection with the selected play one;
storing, in a user personal profile (UPP), the selected play one and the temporal play command;
the display-side controller enabling presentation, on the view display in compliance with the temporal play command, the artwork selection based upon an art play command;
wherein the streaming controller, upon the art play, either substantially contemporaneous with the art play downloads the artwork selection and temporal play command to the display-side controller or prior to the art play has downloaded the artwork selection and temporal play command to the display-side controller.

2. The method for streaming artwork with selection and temporal user controls as claimed in claim 1 wherein:
a sub-plurality of the plurality of discrete visual art pieces and a sub-plurality of the plurality of discrete AV art pieces artwork includes either a portrait-format code or a landscape-format code, the portrait-format code and the landscape-format code for the respective sub-plurality of discrete visual art pieces and respective sub-plurality of discrete AV art pieces being stored in the artwork datastore;
when the selected play one includes a corresponding portrait-format code or a corresponding landscape-format code, the streaming controller downloading, to the display-side controller the corresponding portrait-format code and the corresponding landscape-format code with the artwork selection; and
in the presence of the corresponding portrait-format code and the corresponding landscape-format code, the display-side controller adjusting the view display for (i) a portrait view display in the presence of the corresponding portrait-format code and (ii) a landscape view display in the presence of the corresponding landscape-format code.

3. The method for streaming artwork with selection and temporal user controls as claimed in claim 2 including providing a mechanical rotational positioner coupled to and controlled by the display-side controller, the rotational positioner mechanically attached to the view display and rotating the view display to either a portrait portrayal or a landscape portrayal in the presence of the corresponding portrait-format code and the corresponding landscape-format code, the rotation of the view display is either prior to or during the presentation of the respective sub-plurality of discrete visual art pieces and sub-plurality of discrete AV art pieces.

4. The method for streaming artwork with selection and temporal user controls as claimed in claim 2 including providing a user acoustic player, the acoustic player permitting audio presentation of the plurality of AV art pieces, and including initializing the UPP prior to the art play by:
accepting the artwork selection for the selected play one visual art piece or AV art piece respectively;
accepting the temporal play command in connection with the selected play one; and
storing the selected play one and the temporal play command in the UPP.

5. The method for streaming artwork with selection and temporal user controls as claimed in claim 4:
the display-side controller accepting an artwork playlist representing a plurality of artwork selections to be displayed in a sequential display order on the view display, the artwork playlist encompassing the selected play one, thereby permitting presentation of the selected play one art pieces or the artwork playlist;
storing the artwork playlist in the UPP;
wherein in connection with the selected play one, the temporal play command includes a single distinctive per-artwork playtime;
wherein in connection with the artwork playlist, the temporal play command includes one playtime from the group of playtimes including the single distinctive per-artwork playtime, a uniform per-artwork playtime, a per-playlist playtime, a repeat playtime, and a random playtime;
wherein the distinctive per-artwork playtime is uniquely associated with a corresponding one artwork selection from (i) the plurality of discrete visual art pieces or (ii) the plurality of discrete AV art pieces;
wherein the uniform per-artwork playtime applies the same play timeframe to each artwork selection in the artwork playlist;
wherein the per-playlist playtime applies a total play timeframe for the display of all artwork selections in the artwork playlist;
wherein the repeat playtime applies a repeat display of one artwork selection or the artwork playlist; and
wherein the random playtime applies a randomized display order to the artwork playlist.

6. The method for streaming artwork with selection and temporal user controls as claimed in claim 5:
wherein the artwork datastore is a plurality of artwork datastores, and the streaming controller accessing and obtaining artwork selection from the plurality of artwork datastores wherein each artwork selection has a corresponding datastore address, the artwork playlist being a list of datastore addresses; and
storing the list of datastore addresses in the UPP.

7. The method for streaming artwork with selection and temporal user controls as claimed in claim 2 wherein the artwork datastore is one NFT datastore from the group of the on-chain NFT datastore and the off-chain NFT datastore;
including providing access to the one NFT datastore via an NFT artwork access control stored in an NFT artwork token wherein the NFT artwork token is a unique NFT artwork token of a plurality of NFT artwork tokens, and wherein the plurality of NFT artwork tokens are maintained on a linked blockchain;
wherein accepting the selected play one is permitted when a user's id associated with the display-side controller is also associated with the unique NFT artwork token.

8. The method for streaming artwork with selection and temporal user controls as claimed in claim 7 including storing the user's id in the UPP to facilitate obtaining the artwork selection from the one NFT datastore.

9. The method for streaming artwork with selection and temporal user controls as claimed in claim 2 including accepting a user autoplay command triggered by one of a time-of-day event and a detected ambient environmental condition;
storing in the UPP a triggered selected play one which is associated with one of the time-of-day event and the detected ambient environmental condition and at least the artwork selection;
the display-side controller responding to the one of the time-of-day event and the detected ambient environmental condition and auto-generating and sending the user autoplay command to the streaming controller; and
the streaming controller, upon the user autoplay command, downloading to the display-side controller the temporal play command and the triggered selected play one artwork selection.

10. The method for streaming artwork with selection and temporal user controls as claimed in claim 2 including applying an encoded digital rights management (DRM) to the artwork selection prior to or during the downloading the artwork selection to the display-side controller.

11. The method for streaming artwork with selection and temporal user controls as claimed in claim 10 wherein the artwork datastore is one NFT datastore from the group of the on-chain NFT datastore and the off-chain NFT datastore;
including providing access to the one NFT datastore via an NFT artwork access control stored in a unique NFT artwork token of a plurality of NFT artwork tokens, and wherein the plurality of NFT tokens are maintained on a linked blockchain;
wherein accepting the selected play one is permitted when a user's id associated with the display-side controller is also associated with the unique NFT artwork token; and
storing the user's id in the UPP to facilitate obtaining the artwork selection from the one NFT datastore.

12. The method for streaming artwork with selection and temporal user controls as claimed in claim 11 including a smart contract (SM) in one SM block of the linked blockchain, the SM including DRM display controls in accordance with the encoded DRM during downloading of the artwork selection to the display-side controller.

13. The method for streaming artwork with selection and temporal user controls as claimed in claim 10 wherein the encoded DRM applies a DRM download action from a group of DRM download actions including a time-limited teaser play of a portion of the artwork selection, a single play of the artwork selection, and a one play of n plays of the artwork selection; and
storing the encoded DRM associated with the selected play one and associated artwork selection in the UPP; and
either the display-side controller or the streaming controller applying the DRM download action to the artwork selection thereby altering presentation of the artwork selection on the view display.

14. The method for streaming artwork with selection and temporal user controls as claimed in claim 12 including:
obtaining via the streaming controller the DRM display controls from the SM block prior to or during obtaining the artwork selection from the one NFT datastore;
wherein the encoded DRM applies a DRM download action from a group of DRM download actions including a time-limited teaser play of a portion of the artwork selection, a single play of the artwork selection, and a one play of n plays of the artwork selection; and
either the display-side controller or the streaming controller applying the DRM download action to the artwork selection thereby altering presentation of the artwork selection on the view display.

15. The method for streaming artwork with selection and temporal user controls as claimed in claim 8 including:
including a smart contract (SM) in one SM block of the linked blockchain, the SM including DRM display controls, the DRM display controls being one of a play-code or a no-play-code;
providing a distributed autonomous organization (DAO) blockchain having a smart DAO contract (SDAO) in a linked DAO cell forming the DAO blockchain; and
the SDAO generating an approved access code to the SM upon an execution output from the SDAO, and the SM generating the play-code upon receipt of the approved access code.

16. A method for distributed streaming artwork with selection and temporal user controls comprising:
providing an artwork datastore storing digital versions of artwork, wherein the artwork is a plurality of discrete visual art pieces and a plurality of discrete audio/visual (AV) art pieces, the artwork datastore having artwork stored in one or more an artwork database, an artwork cloud datastore, an on-chain non-fungible token (NFT) datastore, and an off-chain NFT datastore;
providing access to an audio datastore having a plurality of discrete audio pieces;
providing a user view display and a user acoustic player, the view display permitting the user to display the artwork, the acoustic player permitting audio presentation of the plurality of AV art pieces and the plurality of audio pieces;
providing a display-side controller operative to control the view display and the acoustic player;
providing a distributive streaming controller communicatively coupled to the display-side controller, the streaming controller accessing artwork from the artwork datastore and audio data for the plurality of discrete audio pieces from the audio datastore;
accepting, via the display-side controller, an artwork selection for a selected play one visual art piece or AV art piece respectively from the plurality of discrete visual art pieces and the plurality of discrete AV art pieces;
accepting a temporal play command in connection with the selected play one, the temporal play command being either user-supplied or system-applied;
accepting, via the display-side controller, an audio selection for a selected audio play one audio piece from the plurality of discrete audio pieces, the selected audio play one including a display link causing the selected audio play one audio piece to be presented to the user while the artwork selection is presented on the view display;
when the selected play one includes an AV art piece display link, the streaming controller distributing via download to the display-side controller an audio override;
storing, as an initialization in a user personal profile (UPP), the artwork selection, the selected play one, the temporal play command, the audio selection, the selected audio play one, the display link, and, for the AV art piece display link, the audio override;
the streaming controller obtaining the artwork selection from the artwork datastore and obtaining the audio selection from the audio datastore;
the display-side controller enabling presentation, on the view display and the acoustic player, in compliance with the temporal play command and based upon an art play command: (i) the artwork selection and the audio selection and (ii) in the presence of the audio override, the artwork selection and, substantially simultaneously, the audio selection.
wherein the streaming controller, upon the art play, either substantially contemporaneous with the art play downloads the artwork selection and temporal play command to the display-side controller or prior to the art play has downloaded the artwork selection and temporal play command to the display-side controller.

17. The method for streaming artwork with selection and temporal user controls as claimed in claim 16 wherein:
a sub-plurality of the plurality of discrete visual art pieces and a sub-plurality of the plurality of discrete AV art pieces artwork includes either a portrait-format code or a landscape-format code, the portrait-format code and the landscape-format code for the respective sub-plurality of discrete visual art pieces and respective sub-plurality of discrete AV art pieces being stored in the artwork datastore or the UPP;
when the selected play one includes a corresponding portrait-format code or a corresponding landscape-format code, the streaming controller downloading, to the display-side controller the corresponding portrait-format code and the corresponding landscape-format code with the artwork selection; and
in the presence of the corresponding portrait-format code and the corresponding landscape-format code, the display-side controller adjusting the view display for (i) a portrait view display in the presence of the corresponding portrait-format code and (ii) a landscape view display in the presence of the corresponding landscape-format code.

18. The method for streaming artwork with selection and temporal user controls as claimed in claim 17 including providing a mechanical rotational positioner coupled to and controlled by the display-side controller, the rotational positioner mechanically attached to the view display and rotating the view display to either a portrait portrayal or a landscape portrayal in the presence of the corresponding portrait-format code and the corresponding landscape-format code, the rotation of the view display is either prior to or during the presentation of the respective sub-plurality of discrete visual art pieces and sub-plurality of discrete AV art pieces.

19. The method for streaming artwork with selection and temporal user controls as claimed in claim 17:
wherein accepting the artwork selection and the selected play one includes (a) obtaining the artwork selection and the selected play one from the display-side controller and (b) storing the artwork selection and the selected play one in the UPP;
the display-side controller accepting an artwork playlist representing a plurality of artwork selections to be displayed in a sequential display order on the view display;
storing the artwork playlist in the UPP;
wherein the temporal play command includes one playtime from the group of playtimes including a single distinctive per-artwork playtime, a uniform per-artwork playtime, a per-playlist playtime, a repeat playtime, and a random playtime;
wherein the distinctive per-artwork playtime is uniquely associated with a corresponding one artwork selection from (i) the plurality of discrete visual art pieces or (ii) the plurality of discrete AV art pieces;
wherein the uniform per-artwork playtime applies the same play timeframe to each artwork selection in the artwork playlist;
wherein the per-playlist playtime applies a total play timeframe for the display of all artwork selections in the artwork playlist;
wherein the repeat playtime applies a repeat display of one artwork selection or the artwork playlist; and
wherein the random playtime applies a randomized display order to the artwork playlist.

20. The method for streaming artwork with selection and temporal user controls as claimed in claim 19 wherein the artwork datastore is a plurality of artwork datastores; and the streaming controller accessing and obtaining artwork selection from the plurality of artwork datastores;
wherein each artwork selection has a corresponding datastore address, the artwork playlist being a list of datastore addresses; and
storing the list of datastore addresses in the UPP.

21. The method for streaming artwork with selection and temporal user controls as claimed in claim 17 including accepting a user autoplay command triggered by one of a time-of-day event and a detected ambient environmental condition;
storing in the UPP a triggered selected play one which is associated with one of the time-of-day event and the detected ambient environmental condition and at least the artwork selection;
the display-side controller responding to the one of the time-of-day event and the detected ambient environmental condition and auto-generating and sending the user autoplay command to the streaming controller; and
the streaming controller, upon the user autoplay command, downloading to the display-side controller the temporal play command and the triggered selected play one artwork selection.

22. The method for streaming artwork with selection and temporal user controls as claimed in claim 21 including applying an encoded digital rights management (DRM) to the artwork selection prior to or during the downloading the artwork selection to the display-side controller.
